(19) United States
(12) Patent Application Publication
(10) Pub. No.: US 2025/0238965 A1
(43) Pub. Date: Jul. 24, 2025

(54) CODING METHOD AND STORAGE MEDIUM

(71) Applicant: GUANGDONG OPPO MOBILE TELECOMMUNICATIONS CORP., LTD., Dongguan (CN)

(72) Inventor: Chuang MA, Dongguan (CN)

(21) Appl. No.: 19/176,406

(22) Filed: Apr. 11, 2025

Related U.S. Application Data
(63) Continuation of application No. PCT/CN2022/126027, filed on Oct. 18, 2022.

(51) Int. Cl. G06T 9/40

(52) U.S. Cl. CPC G06T 9/40

(57) ABSTRACT

A coding method and a storage medium are provided. The decoding method includes the following. A point cloud bitstream is decoded to obtain a first flag, where the first flag indicates whether attribute coefficients of at least two first attribute components of a current point are each a first value. When the first flag indicates that the attribute coefficients of the at least two first attribute components are each the first value, it is determined that a first attribute coefficient of a second attribute component of the current point is equal to a second attribute coefficient of the second attribute component plus 1. The second attribute coefficient of the second attribute component is parsed from the point cloud bitstream, and the second attribute component is different from the at least two first attribute components.

### CROSS-REFERENCE TO RELATED APPLICATION(S)

This application is a continuation of International Application No. PCT/CN2022/126027, filed Oct. 18, 2022, the disclosure of which is hereby incorporated by reference in its entirety.

### TECHNICAL FIELD

Embodiments of the disclosure relate to the point cloud compression technology, and relate to, but are not limited to, a coding method and a storage medium.

### BACKGROUND

Point cloud is a collection of irregularly-distributed discrete points in space that represent the spatial structure and surface attributes of a three-dimensional (3D) object or scene. Point cloud data usually includes geometry information and attribute information of a sampling point. The geometry information includes 3D location information (x, y, z) of the sampling point, and the attribute information includes colour information and/or one-dimensional reflectance information, etc., of the sampling point.

The point cloud can represent the spatial structure and surface attributes of the 3D object or scene in a flexible and convenient manner. In addition, since the point cloud is acquired by directly sampling a real object, which can exhibit an extremely realistic effect on the premise of ensuring accuracy, the point cloud has a wide range of application, including virtual reality games, computer-aided design, geographic information systems, autonomous navigation systems, digital cultural heritage, free point-of-view broadcasting, 3D immersive telepresence, 3D reconstruction of biological tissues and organs, and the like.

With an increase in application demand, the processing of massive 3D point cloud data is constrained by storage space and transmission bandwidth. In order to better achieve data management, save storage space of a server, and reduce transmission traffic and transmission time between the server and a client, point cloud compression has become a key issue to promote the development of point cloud industry.

### SUMMARY

According to an aspect of embodiments of the disclosure, an encoding method is provided. The method is applied to an encoder and includes the following. A first flag is encoded to a point cloud bitstream, where the first flag indicates whether attribute coefficients of at least two first attribute components of a current point are each a first value. When the attribute coefficients of the at least two first attribute components are each the first value, a second attribute coefficient of a second attribute component of the current point is encoded to the point cloud bitstream. The second attribute coefficient is equal to a first attribute coefficient of the second attribute component minus 1, and the second attribute component is different from the at least two first attribute components.

According to another aspect of embodiments of the disclosure, a decoding method is provided. The method is applied to a decoder and includes the following. A point cloud bitstream is decoded to obtain a first flag, where the first flag indicates whether attribute coefficients of at least two first attribute components of a current point are each a first value. When the first flag indicates that the attribute coefficients of the at least two first attribute components are each the first value, it is determined that a first attribute coefficient of a second attribute component of the current point is equal to a second attribute coefficient of the second attribute component plus 1. The second attribute coefficient of the second attribute component is parsed from the point cloud bitstream, and the second attribute component is different from the at least two first attribute components.

According to another aspect of embodiments of the disclosure, a non-transitory computer-readable storage medium is provided. The non-transitory computer-readable storage medium is configured to store a point cloud bitstream. The point cloud bitstream is generated according to the encoding method in embodiments of the disclosure.

### BRIEF DESCRIPTION OF THE DRAWINGS

The accompanying drawings herein, which are incorporated in and constitute a part of the specification, illustrate embodiments consistent with the disclosure, and together with the specification, are intended to describe technical solutions of the disclosure. Apparently, the accompanying drawings described below are merely some embodiments of the disclosure. Based on these drawings, those of ordinary skill in the art can also obtain other drawings without creative effort.

The flowchart in the accompanying drawings is only an example description, does not necessarily include all contents and operations/steps, and is not necessarily performed in the order illustrated. For example, some operations/steps can also be decomposed, and some operations/steps can be merged or partially merged. Therefore, the actual execution order may vary according to actual needs.

FIG. 1 is a partial enlarged view of a certain three-dimensional (3D) point cloud picture.

FIG. 2 is a schematic structural diagram of an encoder in a moving picture experts group (MPEG) geometry point cloud compression (G-PCC) attribute coding framework provided in embodiments of the disclosure.

FIG. 3 is a schematic structural diagram of a decoder in an MPEG G-PCC attribute coding framework provided in embodiments of the disclosure.

FIG. 4 is a schematic structural diagram of an audio video coding standard (AVS) encoder provided in embodiments of the disclosure.

FIG. 5 is a schematic structural diagram of an AVS decoder provided in embodiments of the disclosure.

FIG. 6 is a schematic flowchart illustrating implementation of an encoding method provided in embodiments of the disclosure.

FIG. 7 is another schematic flowchart illustrating implementation of an encoding method provided in embodiments of the disclosure.

FIG. 8 is yet another schematic flowchart illustrating implementation of an encoding method provided in embodiments of the disclosure.

FIG. 9 is a schematic flowchart illustrating implementation of a decoding method provided in embodiments of the disclosure.

FIG. 10 is another schematic flowchart illustrating implementation of a decoding method provided in embodiments of the disclosure.

FIG. 11 is yet another schematic flowchart illustrating implementation of a decoding method provided in embodiments of the disclosure.

FIG. 12 is still another schematic flowchart illustrating implementation of an encoding method provided in embodiments of the disclosure.

FIG. 13 is still another schematic flowchart illustrating implementation of a decoding method provided in embodiments of the disclosure.

FIG. 14 is another schematic flowchart illustrating implementation of an encoding method provided in embodiments of the disclosure.

FIG. 15 is another schematic flowchart illustrating implementation of a decoding method provided in embodiments of the disclosure.

FIG. 16 is a schematic structural diagram of an encoding apparatus provided in embodiments of the disclosure.

FIG. 17 is a schematic structural diagram of a decoding apparatus provided in embodiments of the disclosure.

FIG. 18 is a schematic structural diagram of a decoder provided in embodiments of the disclosure.

FIG. 19 is a schematic structural diagram of an encoder provided in embodiments of the disclosure.

### DETAILED DESCRIPTION

In order to make purposes, technical solutions, and advantages of embodiments of the disclosure clearer, the following will further describe in detail specific technical solutions of the disclosure with reference to the accompanying drawings in embodiments of the disclosure. Embodiments hereafter are for illustration of the disclosure and are not intended to limit the scope of the disclosure.

Unless otherwise defined, all technical and scientific terms used herein have the same meaning as commonly understood by those skilled in the art. The terms used herein are for the purpose of describing embodiments of the disclosure only and are not intended to limit the disclosure.

In the following description, reference to “some embodiments” describes a subset of all possible embodiments, but it may be understood that “some embodiments” may refer to the same or different subsets of all possible embodiments and may be combined with each other without conflict.

It may be noted that the terms “first/second/third” in embodiments of the disclosure are for distinguishing similar or different objects and do not imply a particular ordering with respect to the objects. It may be understood that “first/second/third” may, where appropriate, be interchanged in a particular order or sequence so that embodiments of the disclosure described herein may be implemented in an order other than that illustrated or described herein.

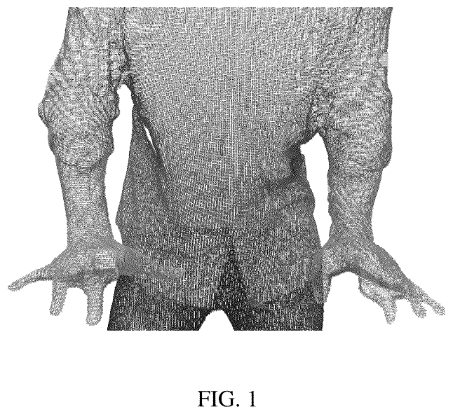

Point cloud is a collection of irregularly-distributed discrete points in space that represent the spatial structure and surface attributes of a three-dimensional (3D) object or scene. FIG. 1 is a partial enlarged view of a certain 3D point cloud picture, and as can be seen, a surface of the point cloud is composed of densely-distributed points.

Since a two-dimensional picture has information representation at each pixel distributed regularly, location information thereof does not need to be recorded additionally. However, since points in the point cloud are distributed randomly and irregularly in 3D space, a location of each point in the space needs to be recorded, so that the point cloud can be represented completely. Similar to the two-dimensional picture, each location has corresponding attribute information in a capturing process, that is, usually a red green blue (RGB) colour value. A colour value reflects a colour of an object. For the point cloud, in addition to colours, the attribute information corresponding to each point often includes reflectance. The reflectance reflects a surface material of an object. Therefore, the point cloud usually includes geometry information consisting of 3D location information (x, y, z) and attribute information consisting of 3D colour information (r, g, b) and one-dimensional reflectance information (r).

The point cloud may be mainly captured in the following ways: computer generation, 3D laser scanning, 3D photogrammetry, and the like. Point cloud of a virtual 3D object or scene may be generated by the computer. Point cloud of a 3D object or scene in a static real world may be acquired through 3D laser scanning, with millions of points acquired every second. Point cloud of a 3D object or scene in a dynamic real world may be acquired through 3D photogrammetry, with tens of millions of points acquired every second. These technologies have reduced the acquisition cost and the time period of point cloud data, and improved the accuracy of the data. The transformation of the method for acquiring point cloud data makes it possible to acquire a large amount of point cloud data. With an increase in application demand, the processing of massive 3D point cloud data is constrained by storage space and transmission bandwidth.

For example, a point cloud video has a frame rate of 30 frames per second (fps). The number of points in each frame of point cloud is 700 thousand. Each point has float coordinate information (x, y, z) and uchar colour information (r, g, b). In this case, a 10s point cloud video has a data volume of approximately 3.15 GB (0.7 million·(4 Byte·3+1 Byte·3)·30 fps·10s=3.15 GB). For a 1280×720 two-dimensional video with a YUV sampling format of 4:2:0 and a frame rate of 24 fps, the data volume of the 10s video is approximately 0.33 GB (1280·720·12 bit·24 frames· 10s≈0.33 GB). A 10s two-view 3D video has a data volume of approximately 0.66 GB (0.33·2=0.66 GB). As can be seen, the data volume of the point cloud video is much greater than the data volume of the two-dimensional video and the data volume of the 3D video with the same duration. Therefore, in order to better achieve data management, save storage space of a server, and reduce transmission traffic and transmission time between the server and a client, point cloud compression has become a key issue to promote the development of point cloud industry.

In a moving picture experts group (MPEG) geometry point cloud compression (G-PCC) encoder framework for a point cloud, geometry information of the point cloud and attribute information corresponding to each point are encoded separately. A G-PCC reference software attribute coding framework may be based on a Pred branch, a PredLift branch, and/or a region adaptive hierarchical transform (RAHT) branch.

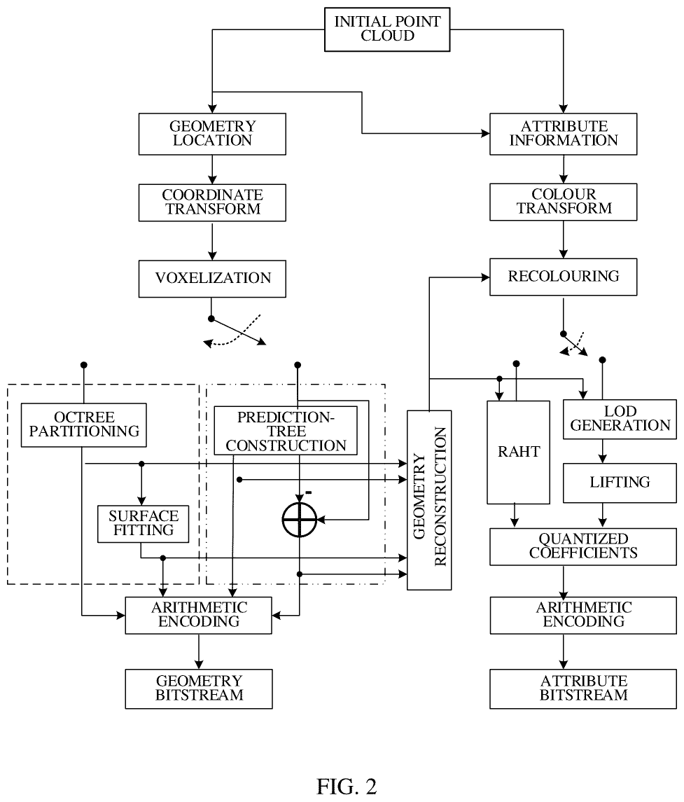

FIG. 2 illustrates a structure of an encoder in an MPEG G-PCC attribute coding framework. As illustrated in FIG. 2, during geometry encoding, coordinate transform is performed on geometry information such that the whole point cloud is contained in a bounding box. This is followed by quantization, which is mainly a scaling process. Due to rounding in the quantization, the geometry information of part of the point cloud is the same, and thus whether to remove duplicate points is determined based on parameters. The process of quantizing and removing the duplicate points is also called voxelization. Next, octree partitioning or prediction-tree construction is performed on the bounding box. In this process, arithmetic encoding is performed on points in the partitioned leaf node, to generate a binary geometry bitstream. Alternatively, arithmetic encoding is performed on the vertex generated from partitioning (surface fitting is performed based on the vertex), to generate a binary geometry bitstream. During attribute encoding, after the geometry encoding is completed and the geometry information is reconstructed, colour transform needs to be first performed, that is, colour information (i.e., attribute information) is transformed from the RGB colour space to the YUV colour space. Thereafter, the reconstructed geometry information is used to recolour the point cloud, so that the uncoded attribute information can correspond to the reconstructed geometry information. The attribute encoding is mainly performed on the colour information. During encoding of the colour information, there are mainly two transform methods. One is distance-based lifting transform which relies on level of detail (LOD) partitioning, and the other is direct RAHT, both of which transform the colour information from the spatial domain to the frequency domain to obtain high-frequency coefficients and low-frequency coefficients through transform, and finally quantize the coefficients to obtain quantized coefficients. Then, arithmetic encoding is performed on the quantized coefficients to generate a binary attribute bitstream.

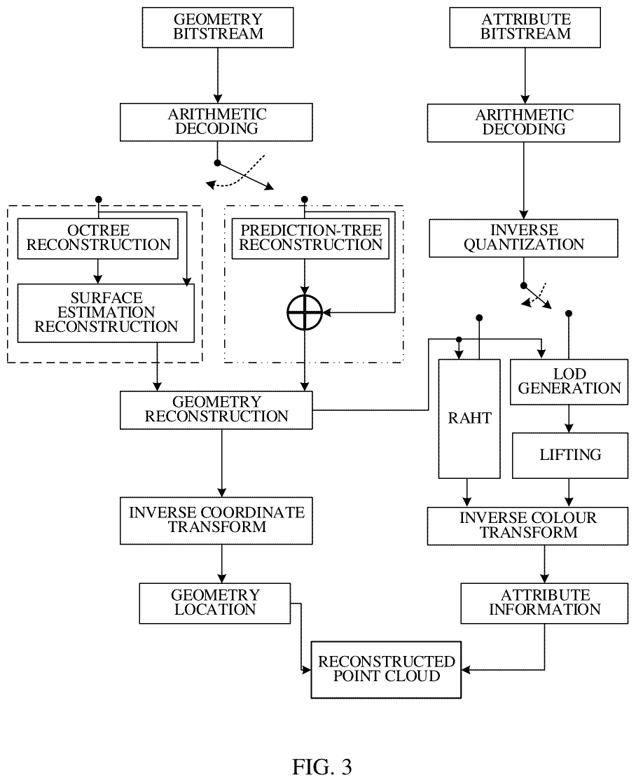

FIG. 3 illustrates a structure of a decoder in an MPEG G-PCC attribute coding framework. As illustrated in FIG. 3, for the obtained binary bitstream, the geometry bitstream and the attribute bitstream in the binary bitstream are first decoded independently. When decoding the geometry bitstream, the geometry information of the point cloud is obtained through arithmetic decoding-octree reconstruction/prediction-tree reconstruction-geometry reconstruction-inverse coordinate transform. When decoding the attribute bitstream, the attribute information of the point cloud is obtained through arithmetic decoding-inverse quantization-LOD partitioning/RAHT-inverse colour transform. The point cloud data to-be-encoded (i.e., the output point cloud) is restored based on the geometry information and the attribute information. The attribute bitstream and the geometry bitstream illustrated in FIG. 2 and FIG. 3 can be understood as a point cloud bitstream.

It may be noted that as illustrated in FIG. 2 and FIG. 3, the MPEG G-PCC geometry coding may be octree based geometry coding (indicated by the dashed boxes) and prediction-tree based geometry coding (indicated by the dash-dot boxes).

Common test conditions for G-PCC are as follows.
1) There are four test conditions in total: condition 1, lossless geometry location and lossy attribute; condition 2, lossy geometry location and lossy attribute; condition 3, lossless geometry location and lossless attribute; and condition 4, lossless geometry location and limit-lossy attribute.

There are four categories of common test sequences, namely Cat1A, Cat1B, Cat3-fused, and Cat3-frame. Cat2-frame point cloud contains only reflectance attribute information, Cat1A point cloud and Cat1B point cloud each contain only colour attribute information, and Cat3-fused point cloud contains both the colour attribute information and the reflectance attribute information.
2) Technical route: based on algorithms used for attribute compression, there are three technical routes below.

Technical route 1: a Pred branch (for condition 3 and condition 4). At the encoding end, an attribute residual coefficient is obtained by using the prediction method Pred, and the attribute residual coefficient is entropy-encoded. At the decoding end, the attribute residual coefficient is obtained through entropy-decoding, and an original value is restored by using the prediction method Pred.

Technical route 2: a Predlift branch (for condition 1 and condition 2). At the encoding end, an attribute transform coefficient is obtained by using the method Predlift, and the attribute transform coefficient is entropy-encoded. At the decoding end, the attribute transform coefficient is obtained through entropy-decoding, and an original value is restored by using the transform method Predlift.

Technical route 3: an RAHT branch (for condition 1 and condition 2). At the encoding end, an attribute transform coefficient is obtained by using the method RAHT, and the attribute transform coefficient is entropy-encoded. At the decoding end, the attribute transform coefficient is obtained through entropy-decoding, and an original value is restored by using the method RAHT.

Attribute entropy-coding is performed on the attribute residual coefficient (the attribute residual coefficient generated through Pred coding) or the attribute transform coefficient (the attribute transform coefficient generated through Predlift coding or RAHT coding) generated according to the above technical routes.

For Pred, for three components of a colour attribute, among value0, value1, and value2 that are subject to prediction and quantization, value0 represents a residual coefficient of Y or R, value1 represents a residual coefficient of U or G, and value2 represents a residual coefficient of V or B.

For PredLift, for three components of a colour attribute, among value0, value1, and value2 that are subject to prediction, transform, and quantization, value0 represents a transform coefficient of Y or R, value1 represents a transform coefficient of U or G, and value2 represents a transform coefficient of V or B.

For RAHT, value0 and value1 and value2 are transform coefficients generated after RAHT and quantization.

For the Pred branch, the PredLift branch, and the RAHT branch, the coding process is described as follows.

Then, at the encoding end, an encoding method is as follows. When value0=value1=value2=0, run length is used for encoding, i.e., run length is encoded. When value0, value1, and value2 are not all 0, value0, value1, and value2 are encoded in the following encoding method.

b0, b1, b2, and b3 are calculated. Herein, b0 indicates whether an absolute value of value1 is equal to 0, b1 indicates whether the absolute value of value1 is less than or equal to 1, b2 indicates whether an absolute value of value2 is equal to 0, and b3 indicates whether the absolute value of value2 is less than or equal to 1.

A G-PCC attribute encoder is used to encode the absolute value of value1 based on a fixed context. It may also be understood that, the G-PCC attribute encoder encodes the absolute value of value1 based on the fixed context.

The G-PCC attribute encoder is used to encode the absolute value of value2 by adaptively selecting a context according to b0 and b1. It may also be understood that, the G-PCC attribute encoder encodes the absolute value of value2 based on a context selected adaptively according to b0 and b1.

When the absolute value of value1 and the absolute value of value2 are both 0, the G-PCC attribute encoder is used to encode an absolute value of value0 minus 1 by adaptively selecting a context according to b0, b1, b2, and b3. It may also be understood that, the G-PCC attribute encoder encodes the absolute value of value0 minus 1 based on a context selected adaptively according to b0, b1, b2, and b3.

When the absolute value of value1 and the absolute value of value2 are not both 0, the G-PCC attribute encoder is used to encode the absolute value of value0 by adaptively selecting a context according to b0, b1, b2, and b3. It may also be understood that, the G-PCC attribute encoder encodes the absolute value of value0 based on a context selected adaptively according to b0, b1, b2, and b3.

Finally, if the absolute value of value0 is not 0, a sign of the absolute value of value0 is encoded. If the absolute value of value1 is not 0, a sign of the absolute value of value1 is encoded. If the absolute value of value2 is not 0, a sign of the absolute value of value2 is encoded.

Accordingly, at the decoding end, a decoding method is as follows. A value of run length is decoded. If the value of run length is not 0, then for subsequent multiple (i.e., run length) points from a current point, value0=value1=value2=0.

When the value of run length is 0, value0, value1, and value2 are decoded in the following decoding method.

A G-PCC attribute decoder is used to decode an absolute value of value1 based on a fixed context. It may also be understood that, the G-PCC attribute decoder decodes the absolute value of value1 based on the fixed context.

b0 and b1 are calculated, where b0 indicates whether the absolute value of value1 is equal to 0, and b1 indicates whether the absolute value of value1 is less than or equal to 1.

The G-PCC attribute decoder is used to decode an absolute value of value2 by adaptively selecting a context according to b0 and b1. It may also be understood that, the G-PCC attribute decoder decodes the absolute value of value2 based on a context selected adaptively according to b0 and b1.

b2 and b3 are calculated, where b2 indicates whether the absolute value of value2 is equal to 0, and b3 indicates whether the absolute value of value2 is less than or equal to 1.

The G-PCC attribute decoder is used to decode an absolute value of value0 by adaptively selecting a context according to b0, b1, b2, and b3. It may be understood that, the G-PCC attribute decoder decodes the absolute value of value0 based on a context selected adaptively according to b0, b1, b2, and b3.

When the absolute value of value1 and the absolute value of value2 are both 0, a final value of the absolute value of value0 is equal to a decoded value of the absolute value of value0 plus 1.

When the absolute value of value1 and the absolute value of value2 are not both 0, the final value of the absolute value of value0 is equal to the decoded value of the absolute value of value0.

Finally, if the final value of the absolute value of value0 is not 0, a sign of the final value of the absolute value of value0 is decoded. If a final value of the absolute value of value1 is not 0, a sign of the final value of the absolute value of value1 is decoded. If a final value of the absolute value of value2 is not 0, a sign of the final value of the absolute value of value2 is decoded.

In an audio video coding standard (AVS) point cloud compression (PCC) attribute encoder framework for a point cloud, geometry information of the point cloud and attribute information corresponding to each point are encoded separately. An AVS PCC reference software attribute coding framework may be based on Pred, Predtrans-resource-constrained, Predtrans-resource-unconstrained, and Trans.

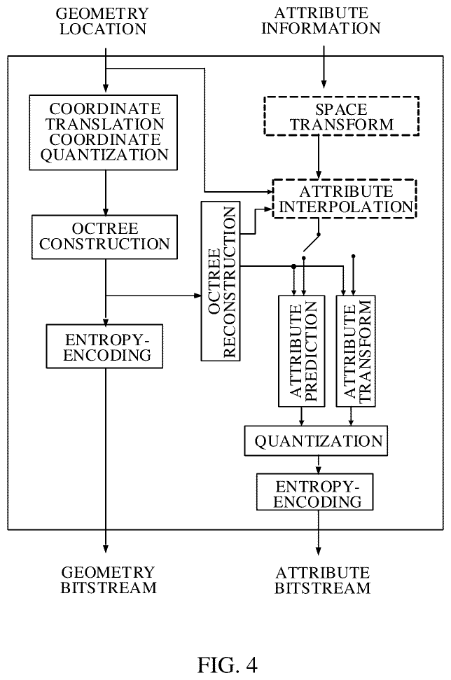

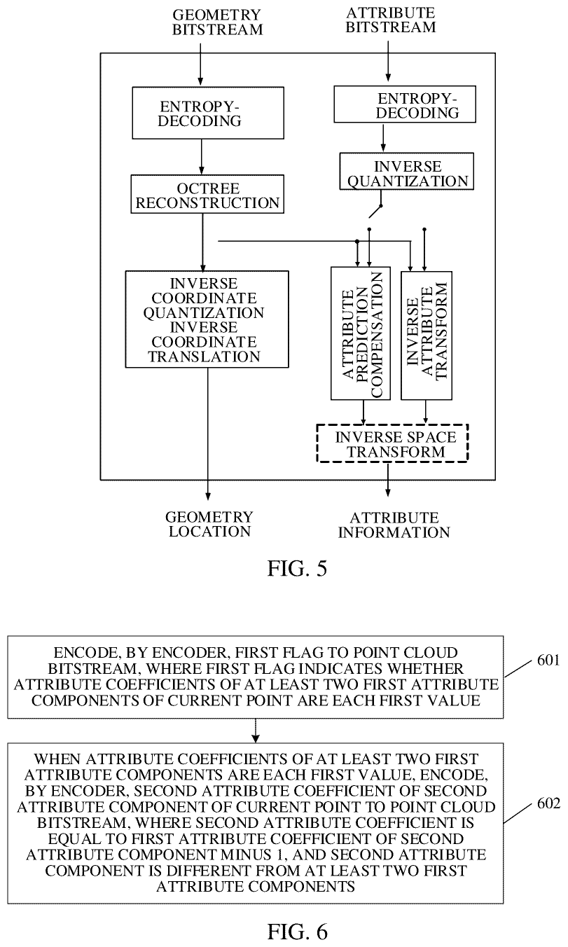

It may be understood that in an AVS coding framework for a point cloud, geometry information of the point cloud and attribute information corresponding to each point are also encoded separately. FIG. 4 is a schematic structural diagram of an AVS encoder, and FIG. 5 is a schematic structural diagram of an AVS decoder.

As illustrated in FIG. 4, in a structural framework of the AVS encoder, coordinate transform is first performed on geometry information such that the whole point cloud is contained in a bounding box. Before pre-processing, whether to partition the whole point cloud sequence into multiple slices is determined according to parameter configuration, and each partitioned slice is regarded as a single independent point cloud for serial processing. The pre-processing includes quantization and removing duplicate points. The quantization is mainly a scaling process. Due to rounding in the quantization, some of the points have the same geometry information, and whether to remove duplicate points is determined according to parameters. Next, (octree/quadtree/binary tree) partitioning is performed on the bounding box in the order of breadth-first search, and an occupancy code of each node is encoded. During octree-based geometry encoding, the bounding box is sequentially partitioned into sub-cubes, and non-empty (containing points in the point cloud) sub-cubes are continued to be partitioned until a resulting leaf node is 1×1×1 unit cube. Then, in case of lossless geometry encoding, the number of points contained in the leaf node is encoded, and finally encoding of a geometry octree is completed, to generate a binary geometry bitstream (i.e., geometry bitstream). The geometry bitstream and the attribute bitstream illustrated in FIG. 4 can be understood as a point cloud bitstream.

As illustrated in FIG. 5, in a structural framework of the AVS decoder, during octree-based geometry decoding, the decoding end obtains an occupancy code of each node through continuous parsing in the order of breadth-first search, and sequentially partitions a node until a 1×1×1 unit cube is obtained. The decoding end parses out the number of points contained in each leaf node and finally restores the geometry information.

After the geometry encoding is completed, the geometry information is reconstructed. The attribute encoding is mainly performed on the colour information and/or the reflectance information. First, whether to perform colour space transform is determined. If colour space transform is performed, the colour information is transformed from the RGB colour space to the YUV colour space. Thereafter, the original point cloud is used to recolour the reconstructed point cloud, so that the uncoded attribute information can correspond to the reconstructed geometry information. There are two modules for encoding of the colour information, namely attribute prediction and attribute transform. The attribute prediction process is as follows: first, the point cloud is reordered, and then differential prediction is performed on the point cloud. There are two reordering methods: Morton reordering and Hilbert reordering. For Cat1A sequence and Cat2 sequence, Hilbert reordering is performed. For Cat1B sequence and Cat3 sequence, Morton reordering is performed. Then, the attribute prediction is performed on a reordered point cloud in a differential manner, and finally a prediction residual is quantized and entropy-encoded to generate a binary attribute bitstream. The attribute transform process is as follows. First, wavelet transform is performed on the point cloud attribute, and a transform coefficient is quantized. Secondly, an attribute reconstruction value is obtained through inverse quantization and inverse wavelet transform. Then, a difference between an original attribute and the attribute reconstruction value is calculated to obtain an attribute residual, and the attribute residual is quantized. Finally, the quantized transform coefficient and attribute residual are entropy-encoded to generate a binary attribute bitstream (i.e., attribute bitstream). In the framework of the AVS decoder, the decoding end finally restores the attribute information through entropy-decoding-inverse quantization-attribute prediction compensation/inverse attribute transform-inverse space transform of the attribute bitstream.

It may be further understood that for the AVS coding framework, common test conditions are as follows.
1) There are four test conditions in total: condition 1, limit-lossy geometry location and lossy attribute; condition 2, lossless geometry location and lossy attribute; condition 3, lossless geometry location and limit-lossy attribute; and condition 4, lossless geometry location and lossless attribute.
2) There are five categories of common test sequences, namely Cat1A, Cat1B, Cat1C, Cat2-frame, and Cat3. Cat1A point cloud and Cat2-frame point cloud each contain only reflectance attribute information, Cat1B point cloud and Cat3 point cloud each contain only colour attribute information, and Cat1C point cloud contains both the colour attribute information and the reflectance attribute information.
3) Technical route: based on algorithms used for attribute compression, there are four technical routes below.

Technical route 1: based on a Pred (predicting) branch, a method based on intra prediction is used for attribute compression.

At the encoding end, points in the point cloud are processed in a certain order (point cloud original-capturing-order, Morton order, or Hilbert order, etc.). First, a prediction algorithm is used to obtain an attribute prediction value, and an attribute residual is obtained according to an attribute value and the attribute prediction value. Then, the attribute residual is quantized to generate a quantized residual. Finally, the quantized residual is encoded.

At the decoding end, points in the point cloud are processed in a certain order (point cloud original-capturing-order, Morton order, or Hilbert order, etc.). First, a prediction algorithm is used to obtain an attribute prediction value. Then, a quantized residual is obtained through decoding, and inverse quantization is performed on the quantized residual. Finally, an attribute reconstruction value is obtained according to the attribute prediction value and the inverse-quantized residual.

Technical route 2: based on Predtrans-resource-constrained (based on the predicting and transform branch-resource-constrained), a method based on intra prediction and discrete cosine transform (DCT) is used for attribute compression. Encoding of quantized transform coefficients is limited by the maximum number M of points (for example, 4096), i.e., each group of up to M points is encoded.

At the encoding end, points in the point cloud are processed in a certain order (point cloud original-capturing-order, Morton order, or Hilbert order, etc.). First, the whole point cloud is divided into several small groups with the maximum length of N (for example, 2), and the several small groups are combined into several large groups (where the number of points in each large group is no more than M, such as 4096). Then, a prediction algorithm is used to obtain an attribute prediction value, an attribute residual is obtained according to an attribute value and the attribute prediction value, and DCT is performed on the attribute residual in a unit of a small group to generate a transform coefficient. Next, the transform coefficient is quantized to generate a quantized transform coefficient. Finally, the quantized transform coefficient is encoded in a unit of a large group.

At the decoding end, points in the point cloud are processed in a certain order (point cloud original-capturing-order, Morton order, or Hilbert order, etc.). First, the whole point cloud is divided into several small groups with the maximum length of N (for example, 2). Thereafter, the several small groups are combined into several large groups (where the number of points in each large group is no more than M, such as 4096), and a quantized transform coefficient is obtained through decoding in a unit of a large group. Then, a prediction algorithm is used to obtain an attribute prediction value, and the quantized transform coefficient is inverse-quantized and inverse-transformed in a unit of a small group. Finally, an attribute reconstruction value is obtained according to the attribute prediction value and the inverse-quantized and inverse-transformed coefficient.

Technical route 3: based on Predtrans-resource-unconstrained (based on the predicting and transform branch-resource-unconstrained), a method based on intra prediction and DCT is used for attribute compression. Encoding of quantized transform coefficients is not limited by the maximum number M of points, i.e., all coefficients are encoded together.

At the encoding end, points in the point cloud are processed in a certain order (point cloud original-capturing-order, Morton order, or Hilbert order, etc.). First, the whole point cloud is divided into several small groups with the maximum length of N (for example, 2). Then, a prediction algorithm is used to obtain an attribute prediction value, an attribute residual is obtained according to an attribute value and the attribute prediction value, and DCT is performed on the attribute residual in a unit of a small group to generate a transform coefficient. Next, the transform coefficient is quantized to generate a quantized transform coefficient. Finally, the quantized transform coefficient of the whole point cloud is encoded.

At the decoding end, points in the point cloud are processed in a certain order (point cloud original-capturing-order, Morton order, or Hilbert order, etc.). First, the whole point cloud is divided into several small groups with the maximum length of N (for example, 2), and a quantized transform coefficient of the whole point cloud is obtained through decoding. Then, a prediction algorithm is used to obtain an attribute prediction value, and the quantized transform coefficient is inverse-quantized and inverse-transformed in a unit of a small group. Finally, an attribute reconstruction value is obtained according to the attribute prediction value and the inverse-quantized and inverse-transformed coefficient.

Technical route 4: based on a Trans branch (a multi-layer transform branch), a method based on multi-layer wavelet transform is used for attribute compression.

At the encoding end, multi-layer wavelet transform is performed on the whole point cloud to generate a transform coefficient. Then, the transform coefficient is quantized to generate a quantized transform coefficient. Finally, the quantized transform coefficient of the whole point cloud is encoded.

At the decoding end, a quantized transform coefficient of the whole point cloud is obtained through decoding, and then the quantized transform coefficient is inverse-quantized and inverse-transformed to obtain an attribute reconstruction value.

Attribute entropy-coding is performed on the attribute residual coefficient (the attribute residual coefficient generated through Pred coding) or the attribute transform coefficient (through Predtrans-resource-constrained, Predtrans-resource-unconstrained, Trans) generated according to the above technical routes.

The above attribute entropy-coding manner is as follows.

For Pred, among value0, value1, and value2 that are subject to prediction and quantization, value0 represents a residual coefficient of Y or R, value1 represents a residual coefficient of U or G, and value2 represents a residual coefficient of V or B.

For Predtrans-resource-constrained and Predtrans-resource-unconstrained, value0, value1, and value2 are direct current (DC) coefficients and alternating current (AC) coefficients that are subject to transform and quantization, which are also referred to as transform coefficients.

For Trans, value0, value1, and value2 are transform coefficients that are subject to multi-layer transform and quantization.

An AVS PCC coding scheme is described as follows.

At the encoding end, an encoding method is described as follows.
1. A flag is encoded based on a fixed context, where the flag indicates whether value1 is 0.
2. If value1 is 0, a flag is further encoded based on the fixed context, where the flag indicates whether value0 is 0.
1) If value1 and value0 are both 0, an absolute value of value2 minus 1 and a sign thereof are encoded based on the fixed context.
2) If value1 is 0 but value0 is not 0, an absolute value of value0 minus 1 and a sign thereof are encoded based on the fixed context, and value2 and a sign of value2 are further encoded based on the fixed context.
3. If value1 is not 0, an absolute value of value1 minus 1 and a sign thereof are encoded based on the fixed context, value0 and a sign of value0 are further encoded based on the fixed context, and value2 and a sign of value2 are further encoded based on the fixed context. At the decoding end, a decoding method is described as follows.
1. A flag is decoded based on a fixed context, where the flag indicates whether value1 is 0.
2. If value1 is 0, a flag is further decoded based on the fixed context, where the flag indicates whether value0 is 0.
1) If value1 and value0 are both 0, an absolute value of value2 and a sign thereof are decoded based on the fixed context. A final value of the absolute value of value2 is equal to a decoded value of the absolute value of value2 plus 1.
2) If value1 is 0 but value0 is not 0, an absolute value of value0 and a sign thereof are decoded based on the fixed context, and value2 and a sign of value2 are further decoded based on the fixed context. A final value of the absolute value of value0 is equal to a decoded value of the absolute value of value0 plus 1.
3. If value1 is not 0, an absolute value of value1 and a sign thereof are decoded based on the fixed context, value0 and a sign of value0 are further decoded based on the fixed context, and value2 and a sign of value2 are further decoded based on the fixed context. A final value of the absolute value of value1 is equal to a decoded value of the absolute value of value1 plus 1.

For encoding of the values as above, value0, value1, and value2 are encoded separately. In the following embodiments, joint encoding is taken into consideration, i.e., a flag can be used to encode both value1 and value2. In addition, an encoded value is used for adaptive selection of a context for encoding, thereby saving codewords. A principle for the decoding end is also similar.

In view of this, an encoding method is first provided in embodiments of the disclosure. The method can be applied to arithmetic encoding in attribute encoding of the encoder illustrated in FIG. 2, and can also be applied to entropy-encoding in attribute encoding of the encoder illustrated in FIG. 4. Certainly, the method is not limited to only the encoders illustrated in FIG. 2 and FIG. 4. The service scenarios and frameworks of the encoder and decoder described in embodiments of the disclosure are intended to describe the technical solutions of embodiments of the disclosure more clearly, and do not constitute limitation on the technical solutions provided in embodiments of the disclosure. Those of ordinary skill in the art can appreciate that, with evolution of the encoder and decoder and emergence of new service scenarios, for similar technical problems, the technical solutions provided in embodiments of the disclosure are also applicable.

FIG. 6 is a schematic flowchart illustrating implementation of an encoding method provided in embodiments of the disclosure. As illustrated in FIG. 6, the method includes operations at 601 and 602 below.

At 601, an encoder encodes a first flag to a point cloud bitstream. The first flag indicates whether attribute coefficients of at least two first attribute components of a current point are each a first value.

In embodiments of the disclosure, the number of bits of the first flag is not limited, which may be one bit or multiple bits. For example, when one bit is used to encode the first flag, the first flag being equal to 0 indicates that the attribute coefficients of the at least two first attribute components of the current point are each the first value, and the first flag being equal to 1 indicates that at least one of the attribute coefficients of the at least two first attribute components of the current point is not the first value. Alternatively, the first flag being equal to 1, indicates the attribute coefficients of the at least two first attribute components of the current point are each the first value, and the first flag being equal to 0 indicates that at least one of the attribute coefficients of the at least two first attribute components of the current point is not the first value.

At 602, when the attribute coefficients of the at least two first attribute components are each the first value, the encoder encodes a second attribute coefficient of a second attribute component of the current point to the point cloud bitstream. The second attribute coefficient is equal to a first attribute coefficient of the second attribute component minus 1, and the second attribute component is different from the at least two first attribute components.

In embodiments of the disclosure, the first value is not limited. In some embodiments, the first value is 0.

In embodiments of the disclosure, the encoder encodes the first flag to the point cloud bitstream, where the first flag indicates whether the attribute coefficients of the at least two first attribute components (not one attribute component) of the current point are each the first value. When the attribute coefficients of the at least two first attribute components are each the first value, the encoder encodes the second attribute coefficient of the second attribute component of the current point to the point cloud bitstream. As such, compared with directly encoding an attribute coefficient of each attribute component of the current point, encoding the attribute coefficients of the at least two attribute components by encoding the first flag can reduce the amount of information to-be-encoded, thereby improving the encoding efficiency and reducing the bitstream overhead. Accordingly, the decoding efficiency at the decoding end can also be improved.

It may be noted that in a G-PCC coding framework, for Pred, the first attribute coefficient represents an attribute residual coefficient, and for PredLift and RAHT, the first attribute coefficient represents an attribute transform coefficient. In an AVS coding framework, for Pred, the first attribute coefficient represents an attribute residual coefficient. For Predtrans-resource-constrained, Predtrans-resource-unconstrained, and Trans, the first attribute coefficient represents an attribute transform coefficient. Certainly, the first attribute coefficient described in embodiments of the disclosure is not limited to the above coefficient, which may be any coefficient outputted through the previous operations including entropy-coding or arithmetic coding.

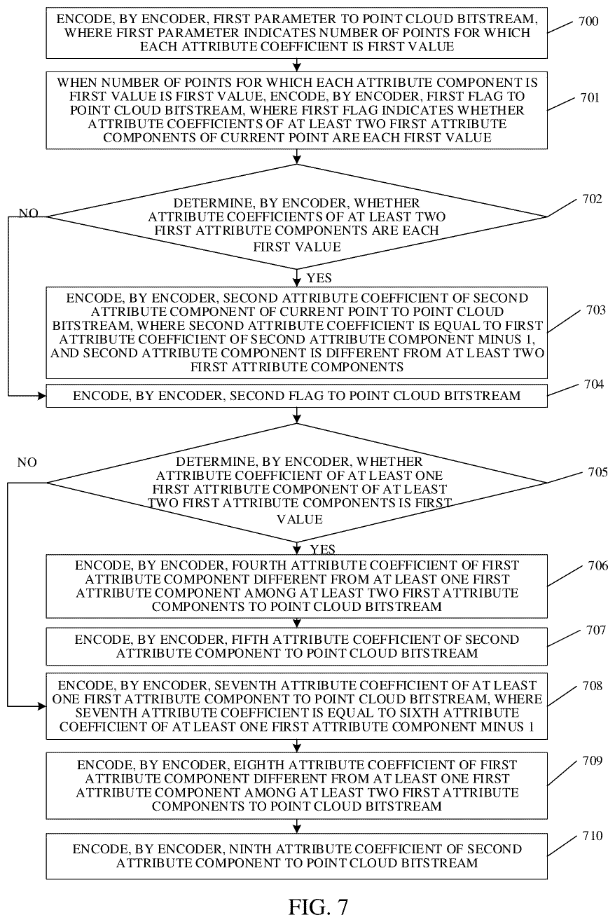

An encoding method is further provided in embodiments of the disclosure. FIG. 7 is another schematic flowchart illustrating implementation of an encoding method provided in embodiments of the disclosure. As illustrated in FIG. 7, the method includes operations at 700 to operations at 710 below.

At 700, an encoder encodes a first parameter to a point cloud bitstream.

In some embodiments, the first parameter indicates the number of consecutive points for which each attribute coefficient is a first value. In some embodiments, the first parameter can be understood as runlength. It may be understood that, runlength indicates that attribute coefficients for consecutive runlength groups (one group of every n, for example, where n is 3) are all 0 or n attribute coefficients (for example, where n is 3) for each of consecutive runlength points are all 0. That is to say, the first parameter indicates the number of consecutive sampling points or the number of consecutive sampling-point groups for which each attribute coefficient is 0. Herein, runlength=0 means that attribute coefficients of all attribute components of a current group are not all 0 or attribute coefficients of all attribute components of a current point are not all 0. First, the encoder encodes runlength. When runlength is equal to 0, the encoder proceeds to the following encoding scheme to save codewords.

In some other embodiments, the first parameter indicates the number of consecutive groups for which each attribute coefficient is the first value. For example, for DCT, runlength in DCT indicates that DCT is performed on m1 points to output k1 transform coefficients (one group of every n (for example, where n is 3)). In this case, runlength being not equal to 0 means that transform coefficients for consecutive runlength groups are all 0, and runlength being equal to 0 means that n transform coefficients (for example, where n is 3) for a current group are not all 0. For another example, for RAHT, runlength in RAHT indicates that RAHT is performed on m2 points to output k2 transform coefficients (one group of every n (for example, where n is 3)). In this case, runlength being not equal to 0 means that transform coefficients for consecutive runlength groups are all 0, and runlength being equal to 0 means that n transform coefficients (for example, where n is 3) for a current group are not all 0.

At 701, when the number of points for which each attribute coefficient is the first value is the first value, the encoder encodes a first flag to the point cloud bitstream. The first flag indicates whether attribute coefficients of at least two first attribute components of a current point are each the first value.

In some embodiments, the first value is 0.

In operations at 701, in some embodiments, the encoder encodes the first flag based on a first context. Further, in some embodiments, the first context is a fixed context.

At 702, the encoder determines whether the attribute coefficients of the at least two first attribute components are each the first value. If the encoder determines that the attribute coefficients of the at least two first attribute components are each the first value, the encoder performs operations at 703, and otherwise, performs operations at 704. That is to say, when at least one of the attribute coefficients of the at least two first attribute components is not the first value, the encoder performs the operations at 704.

At 703, the encoder encodes a second attribute coefficient of a second attribute component of the current point to the point cloud bitstream. The second attribute coefficient is equal to a first attribute coefficient of the second attribute component minus 1, and the second attribute component is different from the at least two first attribute components.

In operations at 703, in some embodiments, the encoder encodes the second attribute coefficient based on a second context. Further, in some embodiments, the second context is a fixed context.

At 704, the encoder encodes a second flag to the point cloud bitstream and proceeds to operations at 705. The second flag indicates whether an attribute coefficient of at least one first attribute component of the at least two first attribute components is the first value.

In some embodiments, the encoder can encode the second flag based on an eleventh context. Further, in some embodiments, the eleventh context is a fixed context.

At 705, the encoder determines whether the attribute coefficient of the at least one first attribute component of the at least two first attribute components is the first value. If the encoder determines that the attribute coefficient of the at least one first attribute component of the at least two first attribute components is the first value, the encoder performs operations at 706, and otherwise, performs operations at 708. That is to say, when the at least one of the attribute coefficients of the at least two first attribute components is not the first value, the encoder performs the operations at 708.

At 706, the encoder encodes a fourth attribute coefficient of a first attribute component different from the at least one first attribute component among the at least two first attribute components to the point cloud bitstream and proceeds to operations at 707. The fourth attribute coefficient is equal to a third attribute coefficient of the first attribute component different from the at least one first attribute component minus 1.

In operations at 706, in some embodiments, the encoder encodes the fourth attribute coefficient based on a third context. Further, in some embodiments, the third context is a fixed context.

At 707, the encoder encodes a fifth attribute coefficient of the second attribute component to the point cloud bitstream.

In operations at 707, in some embodiments, the encoder selects a fourth context based on the third attribute coefficient or the fourth attribute coefficient, and encodes the fifth attribute coefficient based on the fourth context.

Further, in some embodiments, the encoder determines whether an absolute value of the third attribute coefficient or the fourth attribute coefficient is equal to 1 and whether the absolute value of the third attribute coefficient or the fourth attribute coefficient is greater than or equal to 2, and adaptively selects the fourth context based on this. Alternatively, in some other embodiments, the encoder determines whether the absolute value of the third attribute coefficient or the fourth attribute coefficient is equal to 1 and whether the absolute value of the third attribute coefficient or the fourth attribute coefficient is less than or equal to 2, and adaptively select the fourth context based on this.

At 708, the encoder encodes a seventh attribute coefficient of the at least one first attribute component to the point cloud bitstream and proceeds to operations at 709. The seventh attribute coefficient is equal to a sixth attribute coefficient of the at least one first attribute component minus 1.

In operations at 708, in some embodiments, the encoder encodes the seventh attribute coefficient of the at least one first attribute component based on a fifth context. Further, in some embodiments, the fifth context is a fixed context.

At 709, the encoder encodes an eighth attribute coefficient of the first attribute component different from the at least one first attribute component among the at least two first attribute components to the point cloud bitstream and proceeds to operations at 710.

In operations at 709, in some embodiments, the encoder selects a sixth context based on the sixth attribute coefficient or the seventh attribute coefficient, and encodes the eighth attribute coefficient of the first attribute component different from the at least one first attribute component based on the sixth context.

Further, in some embodiments, the encoder determines whether an absolute value of the sixth attribute coefficient or the seventh attribute coefficient is equal to 1 and whether the absolute value of the sixth attribute coefficient or the seventh attribute coefficient is greater than or equal to 2, and adaptively selects the sixth context based on this. Alternatively, in some other embodiments, the encoder determines whether the absolute value of the sixth attribute coefficient or the seventh attribute coefficient is equal to 1 and whether the absolute value of the sixth attribute coefficient or the seventh attribute coefficient is less than or equal to 2, and adaptively select the sixth context based on this.

At 710, the encoder encodes a ninth attribute coefficient of the second attribute component to the point cloud bitstream.

In operations at 710, in some embodiments, the encoder selects a seventh context based on the eighth attribute coefficient and/or one of the sixth attribute coefficient and the seventh attribute coefficient, and encodes the ninth attribute coefficient of the second attribute component based on the seventh context.

For example, the seventh context is selected based on the sixth attribute coefficient and the eighth attribute coefficient. For another example, the seventh context is selected based on the seventh attribute coefficient and the eighth attribute coefficient. For another example, the seventh context is selected based on the sixth attribute coefficient or the seventh attribute coefficient. For another example, the seventh context is selected based on the eighth attribute coefficient.

Further, in some embodiments, the encoder determines whether the absolute value of the sixth attribute coefficient or the seventh attribute coefficient is equal to 1 and whether the absolute value of the sixth attribute coefficient or the seventh attribute coefficient is greater than or equal to 2, and determines whether an absolute value of the eighth attribute coefficient is equal to 0 and whether the absolute value of the eighth attribute coefficient is greater than or equal to 1, so as to jointly and adaptively select the seventh context.

Alternatively, in some other embodiments, the encoder determines whether the absolute value of the sixth attribute coefficient or the seventh attribute coefficient is equal to 1 and whether the absolute value of the sixth attribute coefficient or the seventh attribute coefficient is less than or equal to 2, and determines whether the absolute value of the eighth attribute coefficient is equal to 0 and whether the absolute value of the eighth attribute coefficient is less than or equal to 1, so as to jointly and adaptively select the seventh context.

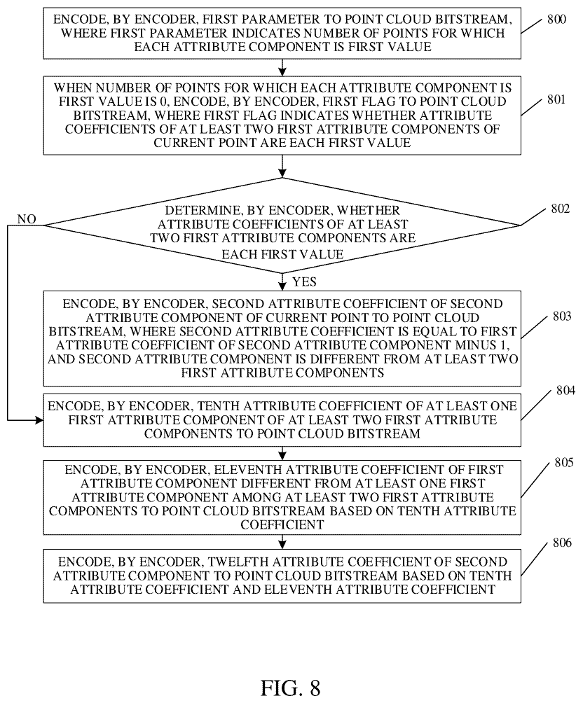

An encoding method is further provided in embodiments of the disclosure. FIG. 8 is yet another schematic flowchart illustrating implementation of an encoding method provided in embodiments of the disclosure. As illustrated in FIG. 8, the method includes operations at 800 to operations at 806 below.

At 800, an encoder encodes a first parameter to a point cloud bitstream.

In some embodiments, the first parameter indicates the number of consecutive points for which each attribute coefficient is a first value. In some other embodiments, the first parameter indicates the number of consecutive groups for which each attribute coefficient is the first value.

At 801, when the number of points for which each attribute coefficient is the first value is the first value, the encoder encodes a first flag to the point cloud bitstream. The first flag indicates whether attribute coefficients of at least two first attribute components of a current point are each the first value.

In some embodiments, the first value is 0.

In operations at 801, in some embodiments, the encoder encodes the first flag based on a first context. Further, in some embodiments, the first context is a fixed context.

At 802, the encoder determines whether the attribute coefficients of the at least two first attribute components are each the first value. If the encoder determines that the attribute coefficients of the at least two first attribute components are each the first value, the encoder performs operations at 803, and otherwise, performs operations at 804. That is to say, when at least one of the attribute coefficients of the at least two first attribute components is not the first value, the encoder performs the operations at 804.

At 803, the encoder encodes a second attribute coefficient of a second attribute component of the current point to the point cloud bitstream. The second attribute coefficient is equal to a first attribute coefficient of the second attribute component minus 1, and the second attribute component is different from the at least two first attribute components.

In operations at 803, in some embodiments, the encoder encodes the second attribute coefficient based on a second context. Further, in some embodiments, the second context is a fixed context.

At 804, the encoder encodes a tenth attribute coefficient of at least one first attribute component of the at least two first attribute components to the point cloud bitstream and proceeds to operations at 805.

In operations at 804, in some embodiments, the encoder encodes the tenth attribute coefficient based on an eighth context. Further, in some embodiments, the eighth context is a fixed context.

At 805, the encoder encodes an eleventh attribute coefficient of a first attribute component different from the at least one first attribute component among the at least two first attribute components to the point cloud bitstream based on the tenth attribute coefficient, and proceeds to operations at 806.

In operations at 805, in some embodiments, the encoder selects a ninth context based on the tenth attribute coefficient, and encodes the eleventh attribute coefficient based on the ninth context.

Further, in some embodiments, the encoder determines whether an absolute value of the tenth attribute coefficient is equal to 1 and whether the absolute value of the tenth attribute coefficient is greater than or equal to 2, and adaptively selects the ninth context based on this. Alternatively, in some other embodiments, the encoder determines whether the absolute value of the tenth attribute coefficient is equal to 1 and whether the absolute value of the tenth attribute coefficient is less or equal to 2, and adaptively selects the ninth context based on this.

At 806, the encoder encodes a twelfth attribute coefficient of the second attribute component to the point cloud bitstream based on the tenth attribute coefficient and the eleventh attribute coefficient.

In operations at 806, in some embodiments, the encoder selects a tenth context based on the tenth attribute coefficient and the eleventh attribute coefficient, and encodes the twelfth attribute coefficient based on the tenth context.

Further, in some embodiments, the encoder determines whether the absolute value of the tenth attribute coefficient is equal to 1 and whether the absolute value of the tenth attribute coefficient is greater than or equal to 2, determines whether an absolute value of the eleventh attribute coefficient is equal to 0 and whether the absolute value of the eleventh attribute coefficient is greater than or equal to 1, and adaptively selects the tenth context based on this. Alternatively, in some other embodiments, the encoder determines whether the absolute value of the tenth attribute coefficient is equal to 1 and whether the absolute value of the tenth attribute coefficient is less than or equal to 2, determines whether the absolute value of the eleventh attribute coefficient is equal to 0 and whether the absolute value of the eleventh attribute coefficient is less than or equal to 1, and adaptively selects the tenth context based on this.

In some embodiments, the encoding method described in any one of the above embodiments further includes the following. When a final value of an attribute coefficient of any attribute component is not the first value, a sign of the final value of the attribute coefficient of any attribute component is encoded, where the sign indicates whether the final value of the corresponding attribute coefficient is positive or negative. In view of this, the above-mentioned attribute coefficients each refer to an absolute value of an attribute coefficient.

In some embodiments, the attribute coefficients (which herein refer to attribute coefficients without subtracting 1), namely the first attribute coefficient, the third attribute coefficient, the fifth attribute coefficient, the sixth attribute coefficient, the eighth attribute coefficient, the ninth attribute coefficient, the tenth attribute coefficient, the eleventh attribute coefficient, and the twelfth attribute coefficient, are all determined according to one of Pred, Predlift, RAHT, Predtrans-resource-constrained, Predtrans-resource-unconstrained, and Trans methods.

It may be noted that in a G-PCC coding framework, for Pred, the first attribute coefficient, the third attribute coefficient, the fifth attribute coefficient, the sixth attribute coefficient, the eighth attribute coefficient, the ninth attribute coefficient, the tenth attribute coefficient, the eleventh attribute coefficient, and the twelfth attribute coefficient each represent an attribute residual coefficient. In addition, for PredLift and RAHT, the first attribute coefficient, the third attribute coefficient, the fifth attribute coefficient, the sixth attribute coefficient, the eighth attribute coefficient, the ninth attribute coefficient, the tenth attribute coefficient, the eleventh attribute coefficient, and the twelfth attribute coefficient each represent an attribute transform coefficient. In an AVS coding framework, for Pred, the first attribute coefficient, the third attribute coefficient, the fifth attribute coefficient, the sixth attribute coefficient, the eighth attribute coefficient, the ninth attribute coefficient, the tenth attribute coefficient, the eleventh attribute coefficient, and the twelfth attribute coefficient each represent an attribute residual coefficient. For Predtrans-resource-constrained, Predtrans-resource-unconstrained, and Trans, the first attribute coefficient, the third attribute coefficient, the fifth attribute coefficient, the sixth attribute coefficient, the eighth attribute coefficient, the ninth attribute coefficient, the tenth attribute coefficient, the eleventh attribute coefficient, and the twelfth attribute coefficient each represent an attribute transform coefficient. Certainly, a type of the attribute coefficients described in embodiments of the disclosure is not limited to the above coefficients, which may be any coefficient outputted through the previous operations including entropy-coding or arithmetic coding.

In some embodiments, the encoding method further includes the following. An attribute reconstruction value of an attribute component is obtained at least according to an attribute coefficient of the attribute component. The attribute coefficient of the attribute component is one of: a first attribute coefficient, a third attribute coefficient, a fifth attribute coefficient, a sixth attribute coefficient, an eighth attribute coefficient, a ninth attribute coefficient, a tenth attribute coefficient, an eleventh attribute coefficient, and a twelfth attribute coefficient.

Accordingly, a decoding method is provided in embodiments of the disclosure. The method can be applied to arithmetic decoding in attribute decoding of the decoder illustrated in FIG. 3, and can also be applied to entropy-decoding in attribute decoding of the decoder illustrated in FIG. 5. Certainly, the method is not limited to only the decoders illustrated in FIG. 3 and FIG. 5. The service scenarios and frameworks of the encoder and decoder described in embodiments of the disclosure are intended to describe the technical solutions of embodiments of the disclosure more clearly, and do not constitute limitation on the technical solutions provided in embodiments of the disclosure. Those of ordinary skill in the art can appreciate that, with evolution of the encoder and decoder and emergence of new service scenarios, for similar technical problems, the technical solutions provided in embodiments of the disclosure are also applicable.

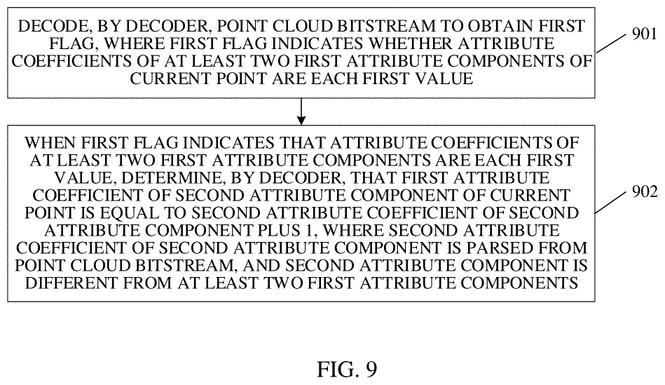

FIG. 9 is a schematic flowchart illustrating implementation of a decoding method provided in embodiments of the disclosure. As illustrated in FIG. 9, the method includes operations at 901 and 902 below.

At 901, a decoder decodes a point cloud bitstream to obtain a first flag. The first flag indicates whether attribute coefficients of at least two first attribute components of a current point are each a first value.

At 902, when the first flag indicates that the attribute coefficients of the at least two first attribute components are each the first value, the decoder determines that a first attribute coefficient of a second attribute component of the current point is equal to a second attribute coefficient of the second attribute component plus 1. The second attribute coefficient of the second attribute component is parsed from the point cloud bitstream, and the second attribute component is different from the at least two first attribute components.

In some embodiments, the first value is 0.

In embodiments of the disclosure, the first flag indicates whether the attribute coefficients of the at least two first attribute components (not one attribute component) of the current point are each the first value. Therefore, when the first flag indicates that the attribute coefficients of the at least two first attribute components are each the first value, the second attribute coefficient of the second attribute component of the current point can be decoded, without a need for decoding an attribute coefficient of each attribute component of the current point, thereby improving the decoding efficiency of the point cloud compression.

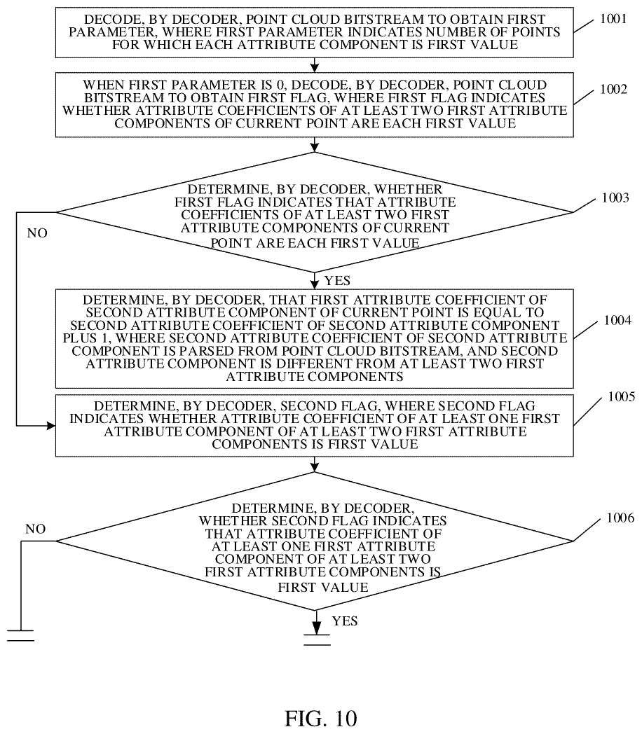

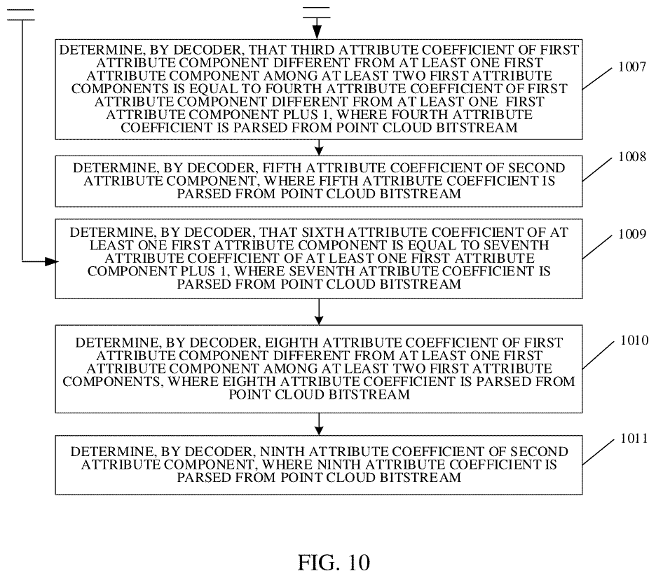

A decoding method is further provided in embodiments of the disclosure. FIG. 10 is another schematic flowchart illustrating implementation of a decoding method provided in embodiments of the disclosure. As illustrated in FIG. 10, the method includes operations at 1001 to operations at 1011 below.

At 1001, a decoder decodes a point cloud bitstream to obtain a first parameter.

In some embodiments, the first parameter indicates the number of consecutive points for which each attribute coefficient is a first value. The first parameter can be understood as runlength. It may be understood that, runlength indicates that attribute coefficients for consecutive runlength groups (one group of every n, where n is 3) are all 0 or n attribute coefficients (where n is 3) for each of consecutive runlength points are all 0. That is to say, the first parameter indicates the number of consecutive sampling points or the number of consecutive sampling-point groups for which each attribute coefficient is 0. Herein, runlength=0 means that a first attribute coefficient, a second attribute coefficient, and a third attribute coefficient of a current group are not all 0 or a first attribute coefficient, a second attribute coefficient, and a third attribute coefficient of a current point are not all 0. First, the decoder decodes runlength. When runlength is equal to 0, the decoder proceeds to the following decoding scheme.

In some other embodiments, the first parameter indicates the number of consecutive groups for which each attribute coefficient is the first value. For example, for DCT, runlength in DCT indicates that DCT is performed on m1 points to output k1 transform coefficients (one group of every n (for example, where n is 3)). In this case, runlength being not equal to 0 means that transform coefficients for consecutive runlength groups are all 0, and runlength being equal to 0 means that n transform coefficients (for example, where n is 3) for a current group are not all 0. For another example, for RAHT, runlength in RAHT indicates that RAHT is performed on m2 points to output k2 transform coefficients (one group of every n (for example, where n is 3)). In this case, runlength being not equal to 0 means that transform coefficients for consecutive runlength groups are all 0, and runlength being equal to 0 means that n transform coefficients (for example, where n is 3) for a current group are not all 0.

At 1002, when the first parameter is the first value, the decoder decodes the point cloud bitstream to obtain a first flag. The first flag indicates whether attribute coefficients of at least two first attribute components of a current point are each the first value.

In some embodiments, the first value is 0.

In operations at 1002, in some embodiments, the decoder decodes, based on a first context, the point cloud bitstream to obtain the first flag.

At 1003, the decoder determines whether the first flag indicates that the attribute coefficients of the at least two first attribute components of the current point are each the first value. If the decoder determines that the first flag indicates that the attribute coefficients of the at least two first attribute components of the current point are each the first value, the decoder performs operations at 1004, and otherwise, performs operations at 1005. That is to say, when the first flag indicates that at least one of the attribute coefficients of the at least two first attribute components is not the first value, the decoder performs the operations at 1005.

At 1004, the decoder determines that a first attribute coefficient of a second attribute component of the current point is equal to a second attribute coefficient of the second attribute component plus 1. The second attribute coefficient of the second attribute component is parsed from the point cloud bitstream, and the second attribute component is different from the at least two first attribute components.

In operations at 1004, in some embodiments, the decoder decodes, based on a second context, the point cloud bitstream to obtain the second attribute coefficient.

At 1005, the decoder determines a second flag and proceeds to operations at 1006. The second flag indicates whether an attribute coefficient of at least one first attribute component of the at least two first attribute components is the first value.

In operations at 1005, in some embodiments, the decoder decodes the point cloud bitstream to obtain the second flag. Further, in some embodiments, the decoder decodes, based on an eleventh context, the point cloud bitstream to obtain the second flag. Further, in some embodiments, the eleventh context is a fixed context.

At 1006, the decoder determines whether the second flag indicates the attribute coefficient of the at least one first attribute component of the at least two first attribute components is the first value. If the decoder determines that the second flag indicates the attribute coefficient of the at least one first attribute component of the at least two first attribute components is the first value, the decoder performs operations at 1007, and otherwise, performs operations at 1009. That is to say, when the second flag indicates that the attribute coefficient of the at least one first attribute component is not the first value, the decoder performs the operations at 1009.

At 1007, the decoder determines that a third attribute coefficient of a first attribute component different from the at least one first attribute component among the at least two first attribute components is equal to a fourth attribute coefficient of the first attribute component different from the at least one first attribute component plus 1, where the fourth attribute coefficient is parsed from the point cloud bitstream. The decoder proceeds to operations at 1008.

In operations at 1007, in some embodiments, the decoder decodes, based on a third context, the point cloud bitstream to obtain the fourth attribute coefficient.

At 1008, the decoder determines a fifth attribute coefficient of the second attribute component. The fifth attribute coefficient is parsed from the point cloud bitstream.

In operations at 1008, in some embodiments, the decoder selects a fourth context based on the third attribute coefficient or the fourth attribute coefficient, and decodes, based on the fourth context, the point cloud bitstream to obtain the fifth attribute coefficient.

At 1009, the decoder determines that a sixth attribute coefficient of the at least one first attribute component is equal to a seventh attribute coefficient of the at least one first attribute component plus 1, where the seventh attribute coefficient is parsed from the point cloud bitstream. The decoder proceeds to operations at 1010.

In operations at 1009, in some embodiments, the decoder decodes, based on a fifth context, the point cloud bitstream to obtain the seventh attribute coefficient of the at least one first attribute component.

At 1010, the decoder determines an eighth attribute coefficient of the first attribute component different from the at least one first attribute component among the at least two first attribute components, and proceeds to operations at 1011. The eighth attribute coefficient is parsed from the point cloud bitstream.

In operations at 1010, in some embodiments, the decoder selects a sixth context based on the sixth attribute coefficient or the seventh attribute coefficient, and decodes, based on the sixth context, the point cloud bitstream to obtain the eighth attribute coefficient of the first attribute component different from the at least one first attribute component.

At 1011, the decoder determines a ninth attribute coefficient of the second attribute component. The ninth attribute coefficient is parsed from the point cloud bitstream.

In operations at 1011, in some embodiments, the decoder selects a seventh context based on the eighth attribute coefficient and/or one of the sixth attribute coefficient and the seventh attribute coefficient, and decodes, based on the seventh context, the point cloud bitstream to obtain the ninth attribute coefficient of the second attribute component.

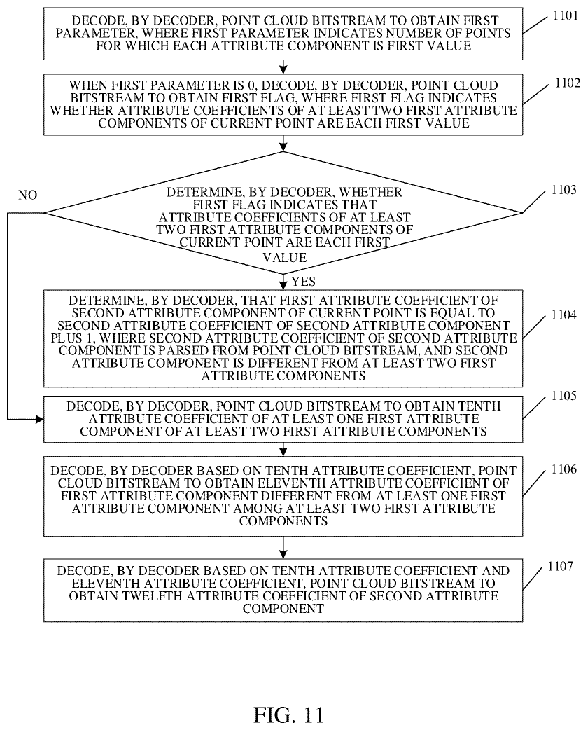

A decoding method is further provided in embodiments of the disclosure. FIG. 11 is yet another schematic flowchart illustrating implementation of a decoding method provided in embodiments of the disclosure. As illustrated in FIG. 11, the method includes operations at 1101 to operations at 1107 below.

At 1101, a decoder decodes a point cloud bitstream to obtain a first parameter.

In some embodiments, the first parameter indicates the number of consecutive points for which each attribute coefficient is a first value. In some other embodiments, the first parameter indicates the number of consecutive groups for which each attribute coefficient is the first value.

At 1102, when the first parameter is the first value, the decoder decodes the point cloud bitstream to obtain a first flag. The first flag indicates whether attribute coefficients of at least two first attribute components of a current point are each the first value.

In operations at 1102, in some embodiments, the decoder decodes, based on a first context, the point cloud bitstream to obtain the first flag.

At 1103, the decoder determines whether the first flag indicates that the attribute coefficients of the at least two first attribute components of the current point are each the first value. If the decoder determines that the first flag indicates that the attribute coefficients of the at least two first attribute components of the current point are each the first value, the decoder performs operations at 1104, and otherwise, performs operations at 1105. That is to say, when the first flag indicates that at least one of the attribute coefficients of the at least two first attribute components is not the first value, the decoder performs the operations at 1105.

At 1104, the decoder determines that a first attribute coefficient of a second attribute component of the current point is equal to a second attribute coefficient of the second attribute component plus 1. The second attribute coefficient of the second attribute component is parsed from the point cloud bitstream, and the second attribute component is different from the at least two first attribute components.

In operations at 1104, in some embodiments, the decoder decodes, based on a second context, the point cloud bitstream to obtain the second attribute coefficient.

At 1105, the decoder decodes the point cloud bitstream to obtain a tenth attribute coefficient of at least one first attribute component of the at least two first attribute components, and proceeds to operations at 1106.

In operations at 1105, in some embodiments, the decoder decodes, based on an eighth context, the point cloud bitstream to obtain the tenth attribute coefficient.

At 1106, the decoder decodes, based on the tenth attribute coefficient, the point cloud bitstream to obtain an eleventh attribute coefficient of a first attribute component different from the at least one first attribute component among the at least two first attribute components, and proceeds to operations at 1107.

In operations at 1106, in some embodiments, the decoder selects a ninth context based on the tenth attribute coefficient, and decodes, based on the ninth context, the point cloud bitstream to obtain the eleventh attribute coefficient.

At 1107, the decoder decodes, based on the tenth attribute coefficient and the eleventh attribute coefficient, the point cloud bitstream to obtain a twelfth attribute coefficient of the second attribute component.

In operations at 1107, in some embodiments, the decoder selects a tenth context based on the tenth attribute coefficient and/or the eleventh attribute coefficient, and decodes, based on the tenth context, the point cloud bitstream to obtain the twelfth attribute coefficient.

In some embodiments, the decoding method described in any one of the above embodiments further includes the following. When a final value of an attribute coefficient of any attribute component is not the first value, the point cloud bitstream is decoded to obtain a sign of the final value of the attribute coefficient of any attribute component. The sign indicates whether the final value of the corresponding attribute coefficient is positive or negative.

In some embodiments, the attribute coefficients (which herein refer to final values of the attribute coefficients for the decoding end), namely the first attribute coefficient, the third attribute coefficient, the fifth attribute coefficient, the sixth attribute coefficient, the eighth attribute coefficient, the ninth attribute coefficient, the tenth attribute coefficient, the eleventh attribute coefficient, and the twelfth attribute coefficient, are all determined according to one of Pred, Predlift, RAHT, Predtrans-resource-constrained, Predtrans-resource-unconstrained, and Trans methods.

It may be noted that in a G-PCC coding framework, for Pred, the first attribute coefficient, the third attribute coefficient, the fifth attribute coefficient, the sixth attribute coefficient, the eighth attribute coefficient, the ninth attribute coefficient, the tenth attribute coefficient, the eleventh attribute coefficient, and the twelfth attribute coefficient each represent an attribute residual coefficient. In addition, for PredLift and RAHT, the first attribute coefficient, the third attribute coefficient, the fifth attribute coefficient, the sixth attribute coefficient, the eighth attribute coefficient, the ninth attribute coefficient, the tenth attribute coefficient, the eleventh attribute coefficient, and the twelfth attribute coefficient each represent an attribute transform coefficient. In an AVS coding framework, for Pred, the first attribute coefficient, the third attribute coefficient, the fifth attribute coefficient, the sixth attribute coefficient, the eighth attribute coefficient, the ninth attribute coefficient, the tenth attribute coefficient, the eleventh attribute coefficient, and the twelfth attribute coefficient each represent an attribute residual coefficient. For Predtrans-resource-constrained, Predtrans-resource-unconstrained, and Trans, the first attribute coefficient, the third attribute coefficient, the fifth attribute coefficient, the sixth attribute coefficient, the eighth attribute coefficient, the ninth attribute coefficient, the tenth attribute coefficient, the eleventh attribute coefficient, and the twelfth attribute coefficient each represent an attribute transform coefficient. Certainly, a type of the attribute coefficients described in embodiments of the disclosure is not limited to the above coefficients, which may be any coefficient outputted through the previous operations including entropy-coding or arithmetic coding.

In some embodiments, the decoding method further includes the following. An attribute reconstruction value of an attribute component is obtained at least according to an attribute coefficient of the attribute component. The attribute coefficient of the attribute component is one of: a first attribute coefficient, a third attribute coefficient, a fifth attribute coefficient, a sixth attribute coefficient, an eighth attribute coefficient, a ninth attribute coefficient, a tenth attribute coefficient, an eleventh attribute coefficient, and a twelfth attribute coefficient.

It may be noted that in the coding scheme provided in embodiments of the disclosure, types of the at least two first attribute components of the current point and the second attribute component of the current point are not limited, and the number of the first attribute components is also not limited. In some embodiments, for a colour attribute, the at least two first attribute components may include any two of a Y component, a U component, and a V component, or the at least two first attribute components may include any two of an R component, a G component, and a B component. Accordingly, the second attribute component is the remaining component different from the at least two first attribute components among the above three components.

In addition, a type of the at least one first attribute component of the at least two first attribute components and a type of the first attribute component different from the at least one first attribute component among the at least two first attribute components are not limited, which may be any one of a Y component, a U component, and a V component or may be any one of an R component, a G component, and a B component.

For example, in some embodiments, the at least two first attribute components include a U component and a V component, and the second attribute component includes a Y component. Based on this, further, in some embodiments, the at least one first attribute component of the at least two first attribute components includes a U component, and the first attribute component different from the at least one first attribute component among the at least two first attribute components is a V component. Alternatively, in some other embodiments, the at least one first attribute component of the at least two first attribute components includes a V component, and the first attribute component different from the at least one first attribute component among the at least two first attribute components is a U component.

In some embodiments, the at least two first attribute components include a U component and a Y component, and the second attribute component includes a V component. Based on this, further, in some embodiments, the at least one first attribute component of the at least two first attribute components includes a U component, and the first attribute component different from the at least one first attribute component among the at least two first attribute components is a Y component. Alternatively, in some other embodiments, the at least one first attribute component of the at least two first attribute components includes a Y component, and the first attribute component different from the at least one first attribute component among the at least two first attribute components is a U component.

In some embodiments, the at least two first attribute components include a V component and a Y component, and the second attribute component includes a U component. Based on this, further, in some embodiments, the at least one first attribute component of the at least two first attribute components includes a V component, and the first attribute component different from the at least one first attribute component among the at least two first attribute components is a Y component. Alternatively, in some other embodiments, the at least one first attribute component of the at least two first attribute components includes a Y component, and the first attribute component different from the at least one first attribute component among the at least two first attribute components is a V component.

Similarly, in some embodiments, the at least two first attribute components include an R component and a G component, and the second attribute component includes a B component. Based on this, further, in some embodiments, the at least one first attribute component of the at least two first attribute components includes an R component, and the first attribute component different from the at least one first attribute component among the at least two first attribute components is a G component. Alternatively, in some other embodiments, the at least one first attribute component of the at least two first attribute components includes a G component, and the first attribute component different from the at least one first attribute component among the at least two first attribute components is an R component.

In some embodiments, the at least two first attribute components include an R component and a B component, and the second attribute component includes a V component. Based on this, further, in some embodiments, the at least one first attribute component of the at least two first attribute components includes an R component, and the first attribute component different from the at least one first attribute component among the at least two first attribute components is a B component. Alternatively, in some other embodiments, the at least one first attribute component of the at least two first attribute components includes a B component, and the first attribute component different from the at least one first attribute component among the at least two first attribute components is an R component.

In some embodiments, the at least two first attribute components include a G component and a B component, and the second attribute component includes an R component. Based on this, further, in some embodiments, the at least one first attribute component of the at least two first attribute components includes a G component, and the first attribute component different from the at least one first attribute component among the at least two first attribute components is a B component. Alternatively, in some other embodiments, the at least one first attribute component of the at least two first attribute components includes a B component, and the first attribute component different from the at least one first attribute component among the at least two first attribute components is a G component.

It may be further noted that, the above decoding method related to FIG. 9 corresponds to the encoding method related to FIG. 6, the above decoding method related to FIG. 10 corresponds to the encoding method related to FIG. 7, and the above decoding method related to FIG. 11 corresponds to the encoding method related to FIG. 8. Therefore, technical details not disclosed in the decoding method are understood with reference to the corresponding explanations and descriptions of the above encoding method. For the sake of brevity, some technical details of the decoding method will not be explained and described herein to avoid repetition.

In some embodiments, a 1-bit flag can indicate whether to enable the encoding method provided in embodiments of the disclosure. That flag is placed in header information attribute header of a high-level syntax element, and that flag is conditionally analyzed under some specific conditions. If that flag does not appear in a bitstream, a default value of that flag is a fixed value. In other words, if that flag does not appear in the bitstream, the encoding method provided in embodiments of the disclosure is enabled/used by default. Alternatively, if that flag does not appear in the bitstream, the encoding method provided in embodiments of the disclosure is not enabled/used by default.

Similarly, the decoding end needs to decode that flag. If that flag does not appear in a bitstream, that flag is not decoded, and a default value of that flag is a fixed value. In other words, if that flag does not appear in the bitstream, the decoding method provided in embodiments of the disclosure is enabled/used by default. Alternatively, if that flag does not appear in the bitstream, the decoding method provided in embodiments of the disclosure is not enabled/used by default.

An exemplary application of embodiments of the disclosure in an actual application scenario will be described below.

A description of a specific scheme at a coding end is as follows.

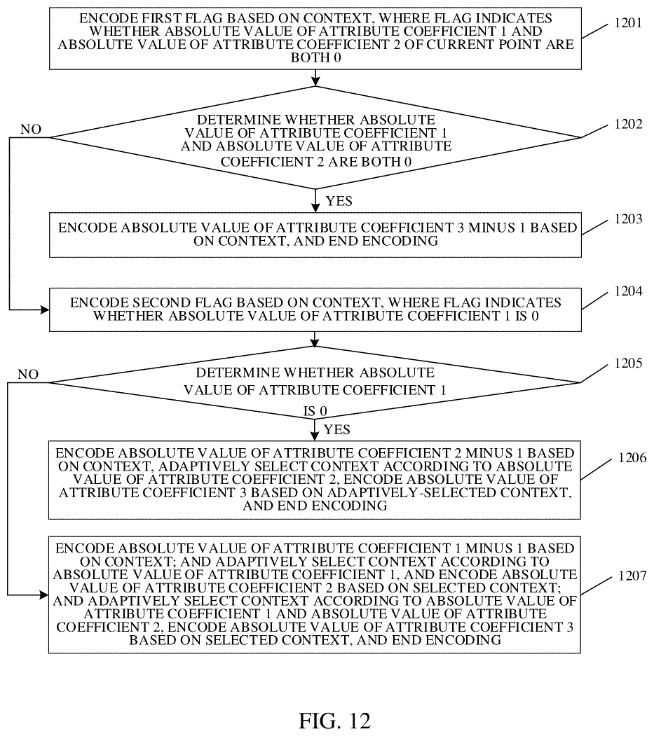

At an encoding end, as illustrated in FIG. 12, operations at 1201 to operations at 1207 below are included.

At 1201, a first flag is encoded based on a context, where the flag indicates whether an absolute value of attribute coefficient 1 and an absolute value of attribute coefficient 2 of a current point are both 0. The absolute value of attribute coefficient 1 and the absolute value of attribute coefficient 2 of the current point refer to examples of the attribute coefficients of the at least two first attribute components of the current point described in the foregoing embodiments.

At 1202, whether the absolute value of attribute coefficient 1 and the absolute value of attribute coefficient 2 are both 0 is determined. If the absolute value of attribute coefficient 1 and the absolute value of attribute coefficient 2 are both 0, operations at 1203 are performed, and otherwise, operations at 1204 are performed.

At 1203, an absolute value of attribute coefficient 3 minus 1 is encoded based on a context, and the encoding ends. The absolute value of attribute coefficient 3 refers to an example of the first attribute coefficient of the second attribute component of the current point described in the foregoing embodiments.

At 1204, a second flag is encoded based on a context. The flag indicates whether the absolute value of attribute coefficient 1 is 0.

At 1205, whether the absolute value of attribute coefficient 1 is 0 is determined. If the absolute value of attribute coefficient 1 is 0, operations at 1206 are performed, and otherwise, operations at 1207 are performed.

At 1206, the absolute value of attribute coefficient 2 minus 1 is encoded based on a context, and a context is adaptively selected according to the absolute value of attribute coefficient 2; the absolute value of attribute coefficient 3 is encoded based on the adaptively-selected context, and the encoding ends.

At 1207, the absolute value of attribute coefficient 1 minus 1 is encoded based on a context; a context is adaptively selected according to the absolute value of attribute coefficient 1, and the absolute value of attribute coefficient 2 is encoded based on the selected context; a context is adaptively selected according to the absolute value of attribute coefficient 1 and the absolute value of attribute coefficient 2, the absolute value of attribute coefficient 3 is encoded based on the selected context, and the encoding ends.

Finally, if the absolute value of attribute coefficient 1 is not 0, a sign of the absolute value of attribute coefficient 1 is encoded. If the absolute value of attribute coefficient 2 is not 0, a sign of the absolute value of attribute coefficient 2 is encoded. If the absolute value of attribute coefficient 3 is not 0, a sign of the absolute value of attribute coefficient 3 is encoded.

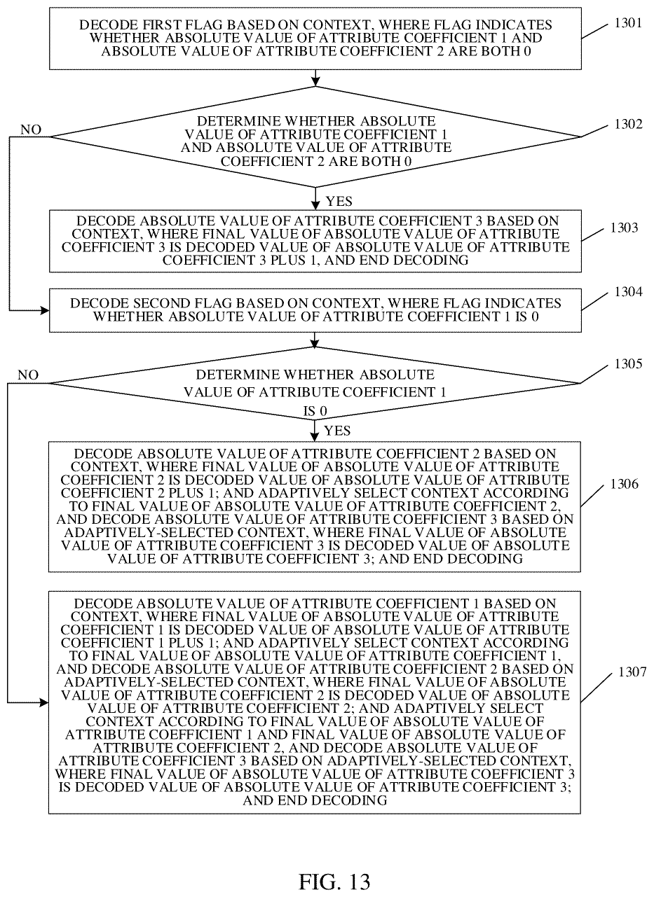

At a decoding end, as illustrated in FIG. 13, operations at 1301 to operations at 1307 below are included.

At 1301, a first flag is decoded based on a context, where the flag indicates whether an absolute value of attribute coefficient 1 and an absolute value of attribute coefficient 2 are both 0.

At 1302, whether the absolute value of attribute coefficient 1 and the absolute value of attribute coefficient 2 are both 0 is determined. If the absolute value of attribute coefficient 1 and the absolute value of attribute coefficient 2 are both 0, operations at 1303 are performed, and otherwise, operations at 1304 are performed.

At 1303, an absolute value of attribute coefficient 3 is decoded based on a context, where a final value of the absolute value of attribute coefficient 3 is a decoded value of the absolute value of attribute coefficient 3 plus 1, and the decoding ends.

At 1304, a second flag is decoded based on a context. The flag indicates whether the absolute value of attribute coefficient 1 is 0.

At 1305, whether the absolute value of attribute coefficient 1 is 0 is determined. If the absolute value of attribute coefficient 1 is 0, operations at 1306 are performed, and otherwise, operations at 1307 are performed.

At 1306, the absolute value of attribute coefficient 2 is decoded based on a context, where a final value of the absolute value of attribute coefficient 2 is a decoded value of the absolute value of attribute coefficient 2 plus 1; a context is adaptively selected according to the final value of the absolute value of attribute coefficient 2, and the absolute value of attribute coefficient 3 is decoded based on the adaptively-selected context, where a final value of the absolute value of attribute coefficient 3 is a decoded value of the absolute value of attribute coefficient 3, and the decoding ends.

At 1307, the absolute value of attribute coefficient 1 is decoded based on a context, where a final value of the absolute value of attribute coefficient 1 is a decoded value of the absolute value of attribute coefficient 1 plus 1; a context is adaptively selected according to the final value of the absolute value of attribute coefficient 1, and the absolute value of attribute coefficient 2 is decoded based on the adaptively-selected context, where the final value of the absolute value of attribute coefficient 2 is the decoded value of the absolute value of attribute coefficient 2; a context is adaptively selected according to the final value of the absolute value of attribute coefficient 1 and the final value of the absolute value of attribute coefficient 2, and the absolute value of attribute coefficient 3 is decoded based on the adaptively-selected context, where the final value of the absolute value of attribute coefficient 3 is the decoded value of the absolute value of attribute coefficient 3, and the decoding ends.

Finally, if the final value of the absolute value of attribute coefficient 1 is not 0, a sign of the final value of the absolute value of attribute coefficient 1 is decoded. If the final value of the absolute value of attribute coefficient 2 is not 0, a sign of the final value of the absolute value of attribute coefficient 2 is decoded. If the final value of the absolute value of attribute coefficient 3 is not 0, a sign of the final value of the absolute value of attribute coefficient 3 is decoded.

### Example 1

For the case where value0, value1, and value2 are encoded based on the Pred branch, PredLift branch, and RAHT branch in G-PCC, for Pred, for three components of a colour attribute, among value0, value1, and value2, value0 represents a residual coefficient of Y or R, value1 represents a residual coefficient of U or G, and value2 represents a residual coefficient of V or B.

For PredLift, for three components of a colour attribute, among value0, value1, and value2, value0 represents a transform coefficient of Y or R, value1 represents a transform coefficient of U or G, and value2 represents a transform coefficient of V or B.

For RAHT, value0 and value1 and value2 are transform coefficients generated after RAHT.

A tool for this scheme can use a 1-bit flag to indicate whether to enable the encoding method and decoding method described below. That flag is placed in header information attribute header of a high-level syntax element, and that flag is conditionally analyzed under some specific conditions. If that flag does not appear in a bitstream, a default value of that flag is a fixed value.

Similarly, the decoding end needs to decode that flag. If that flag does not appear in a bitstream, that flag is not decoded, and a default value of that flag is a fixed value.

At an encoding end, operations described below are included.

A first flag is encoded based on a context, where the first flag indicates whether an absolute value of value1 and an absolute value of value2 are both 0.

Whether the absolute value of value1 and the absolute value of value2 are both 0 is determined. If the absolute value of value1 and the absolute value of value2 are both 0, an absolute value of value0 minus 1 is encoded based on a context, and the encoding ends, and otherwise, a second flag is encoded based on a context, where the second flag indicates whether the absolute value of value1 is 0.

Whether the absolute value of value1 is 0 is determined. If the absolute value of value1 is 0, the absolute value of value2 minus 1 is encoded based on a context, a context is adaptively selected according to the absolute value of value2, the absolute value of value0 is encoded based on the selected context, and the encoding ends, and otherwise, the absolute value of value1 minus 1 is encoded based on a context, and a context is adaptively selected according to the absolute value of value1, the absolute value of value2 is encoded based on the selected context, and the absolute value of value0 is encoded by adaptively selecting a context according to the absolute value of value1 and the absolute value of value2.

The adaptive method refers to adaptive selection of a context according to whether the absolute value of value2 is equal to 1 and whether the absolute value of value2 is greater than or equal to 2 or less than or equal to 2.

The adaptive method refers to adaptive selection of a context according to whether the absolute value of value1 is equal to 1 and whether the absolute value of value1 is greater than or equal to 2 or less than or equal to 2.

The adaptive method refers to joint and adaptive selection of a context according to whether the absolute value of value1 is equal to 1 and whether the absolute value of value1 is greater than or equal to 2 or less than or equal to 2 and according to whether the absolute value of value2 is equal to 0 and whether the absolute value of value2 is greater than or equal to 1 or less than or equal to 1.

Finally, if the absolute value of value0 is not 0, a sign of the absolute value of value0 is encoded. If the absolute value of value1 is not 0, a sign of the absolute value of value1 is encoded. If the absolute value of value2 is not 0, a sign of the absolute value of value2 is encoded.

Accordingly, at a decoding end, operations described below are included.

A first flag is decoded based on a context, where the first flag indicates whether an absolute value of value1 and an absolute value of value2 are both 0.

Whether the absolute value of value1 and the absolute value of value2 are both 0 is determined. If the absolute value of value1 and the absolute value of value2 are both 0, an absolute value of value0 is decoded based on a context, where a final value of the absolute value of value0 is a decoded value of the absolute value of value0 plus 1, and the decoding ends, and otherwise, a second flag is decoded based on a context, where the second flag indicates whether the absolute value of value1 is 0.

Whether the absolute value of value1 is 0 is determined. If the absolute value of value1 is 0, the absolute value of value2 is decoded based on a context, where a final value of the absolute value of value2 is a decoded value of the absolute value of value2 plus 1, and the absolute value of value0 is decoded by adaptively selecting a context according to the final value of the absolute value of value2, where the final value of the absolute value of value0 is the decoded value of the absolute value of value0, and the decoding ends, and otherwise, the absolute value of value1 is decoded based on a context, where a final value of the absolute value of value1 is a decoded value of the absolute value of value1 plus 1, and the absolute value of value2 is decoded by adaptively selecting a context according to the final value of the absolute value of value1, where the final value of the absolute value of value2 is the decoded value of the absolute value of value2, and the absolute value of value0 is decoded by adaptively selecting a context according to the final value of the absolute value of value1 and the final value of the absolute value of value2, where the final value of the absolute value of value0 is the decoded value of the absolute value of value0, and the decoding ends.

The adaptive method refers to adaptive selection of a context according to whether the final value of the absolute value of value2 is equal to 1 and whether the final value of the absolute value of value2 is greater than or equal to 2 or less than or equal to 2.

The adaptive method refers to adaptive selection of a context according to whether the final value of the absolute value of value1 is equal to 1 and whether the final value of the absolute value of value1 is greater than or equal to 2 or less than or equal to 2.

The adaptive method refers to joint and adaptive selection of a context according to whether the final value of the absolute value of value1 is equal to 1 and whether the final value of the absolute value of value1 is greater than or equal to 2 or less than or equal to 2 and according to whether the final value of the absolute value of value2 is equal to 0 and whether the final value of the absolute value of value2 is greater than or equal to 1 or less than or equal to 1.

Finally, if the final value of the absolute value of value0 is not 0, a sign of the final value of the absolute value of value0 is decoded. If the final value of the absolute value of value1 is not 0, a sign of the final value of the absolute value of value1 is decoded. If the final value of the absolute value of value2 is not 0, a sign of the final value of the absolute value of value2 is decoded.

### Example 2

For the case where value0, value1, and value2 are encoded based on the Pred branch, Predtrans-resource-constrained branch, Predtrans-resource-unconstrained branch, or Trans branch in AVS PCC, note: for Pred, for three components of a colour attribute, among value0, value1, and value2, value0 represents a residual coefficient of Y or R, value1 represents a residual coefficient of U or G, and value2 represents a residual coefficient of V or B.

For Predtrans-resource-constrained and Predtrans-resource-unconstrained, value0, value1, and value2 are DC coefficients or AC coefficients that are subject to transform.

For Trans, value0, value1, and value2 are transform coefficients that are subject to multi-layer transform.

A tool for this scheme can use a 1-bit flag to indicate whether to be enabled. That flag is placed in header information attribute header of a high-level syntax element, and that flag is conditionally analyzed under some specific conditions. If that flag does not appear in a bitstream, a default value of that flag is a fixed value.

Similarly, the decoding end needs to decode that flag. If that flag does not appear in a bitstream, that flag is not decoded, and a default value of that flag is a fixed value.

A scheme at the encoding end is the same as the scheme at the encoding end in example 1. A scheme at the decoding end is the same as the scheme at the decoding end in example 1. For the sake of brevity, descriptions will not be repeated herein.

It may be noted that, a method for obtaining any context described in any one of the foregoing embodiments is not limited. In the coding method described in embodiments of the disclosure, whether to use a context for coding or whether to adaptively select a context and then perform coding based on the selected context is optional, and the method can be enabled or not enabled. That is, for coding based on a fixed context, coding may be performed based on the fixed context, or coding may be directly performed without using a context. For coding based on an adaptively-selected context, coding may be performed based on the adaptively-selected context, or coding may be performed based on the fixed context, or coding may be directly performed without using a context.

To verify technical effects of the above embodiments, the above embodiments are compared with a G-PCC anchor. Table 1 demonstrates technical effects achieved by the G-PCC pred-based arithmetic coding method under condition 3, as illustrated in table 1. Herein, “bpip ratio” indicates an input point bitrate, “Geometry” indicates geometry information, “Colour” indicates colour information, “Reflectance” indicates reflectance.

TABLE 1

| Condition 3: lossless geometry | bpip ratio[%] | | |
|---|---|---|---|
| location and lossless attribute | Geometry | Colour | Reflectance |
| Cat1-A average | 100% | 99.9% | 100% |
| Cat1-B average | 100% | 99.7% | 100% |
| Cat3-fused average | 100% | 99.9% | 100% |
| Overall average | 100% | 99.8% | 100% |

| | |
|---|---|
| Avg. Enc Time[%] | 100% |
| Avg. Dec Time[%] | 100% |

Table 2 demonstrates technical effects achieved by the G-PCC pred-based arithmetic coding method under condition 4, as illustrated in table 2. Herein, “End-to-End BD-Attr Rate” indicates an end-to-end attribute rate-distortion rate, “Luma” indicates luma, “ChromaCb” indicates chroma Cb, and “ChromaCr” indicates chroma Cr.

TABLE 2

| Condition 4: lossless geometry | End-to-End BD-Attr Rate [%] | | |
|---|---|---|---|
| location and limit-lossy attribute | Luma | ChromaCb | ChromaCr |
| Cat1-A average | −0.1% | −0.1% | −0.1% |
| Cat1-B average | −0.1% | −0.1% | −0.1% |
| Cat3-fused average | −0.2% | −0.2% | −0.2% |
| Overall average | −0.1% | −0.1% | −0.1% |

| | |
|---|---|
| Avg. Enc Time[%] | 100% |
| Avg. Dec Time[%] | 100% |

Table 3 demonstrates technical effects achieved by the G-PCC predlift-based arithmetic coding method under condition 1, as illustrated in table 3.

TABLE 3

| Condition 1: lossless geometry | End-to-End BD-Attr Rate [%] | | |
|---|---|---|---|
| location and lossy attribute | Luma | ChromaCb | ChromaCr |
| Cat1-A average | −0.3% | −0.2% | −0.3% |
| Cat1-B average | −0.2% | −0.2% | −0.2% |
| Cat3-fused average | −0.2% | −0.3% | −0.3% |
| Overall average | −0.3% | −0.2% | −0.3% |

| | |
|---|---|
| Avg. Enc Time[%] | 100% |
| Avg. Dec Time[%] | 100% |

Table 4 demonstrates technical effects achieved by the G-PCC predlift-based arithmetic coding method under condition 2, as illustrated in table 4.

TABLE 4

| Condition 2: lossy geometry | End-to-End BD-Attr Rate [%] | | |
|---|---|---|---|
| location and lossy attribute | Luma | ChromaCb | ChromaCr |
| Cat1-A average | −0.2% | −0.3% | −0.2% |
| Cat1-B average | −0.3% | −0.3% | −0.3% |
| Cat3-fused average | −0.2% | −0.2% | −0.2% |
| Overall average | −0.2% | −0.3% | −0.2% |

| | |
|---|---|
| Avg. Enc Time[%] | 100% |
| Avg. Dec Time[%] | 100% |

Table 5 demonstrates technical effects achieved by the G-PCC RAHT-based arithmetic coding method under condition 1, as illustrated in table 5.

TABLE 5

| Condition 1: lossless geometry | End-to-End BD-Attr Rate [%] | | |
|---|---|---|---|
| location and lossy attribute | Luma | ChromaCb | ChromaCr |
| Cat1-A average | −0.3% | −0.3% | −0.3% |
| Cat1-B average | −0.3% | −0.3% | −0.3% |
| Cat3-fused average | −0.2% | −0.3% | −0.3% |
| Overall average | −0.3% | −0.3% | −0.3% |

| | |
|---|---|
| Avg. Enc Time[%] | 100% |
| Avg. Dec Time[%] | 100% |

Table 6 demonstrates technical effects achieved by the G-PCC RAHT-based arithmetic coding method under condition 2, as illustrated in table 6.

TABLE 6

| Condition 2: lossy geometry | End-to-End BD-Attr Rate [%] | | |
|---|---|---|---|
| location and lossy attribute | Luma | ChromaCb | ChromaCr |
| Cat1-A average | −0.3% | −0.3% | −0.4% |
| Cat1-B average | −0.3% | −0.3% | −0.3% |
| Cat3-fused average | −0.2% | −0.3% | −0.3% |
| Overall average | −0.3% | −0.3% | −0.3% |

| | |
|---|---|
| Avg. Enc Time[%] | 100% |
| Avg. Dec Time[%] | 100% |

As can be seen from this, the above embodiments can achieve a stable performance gain without increasing the time complexity.

It may be noted that, (1) the above embodiments are applied to colour attribute coefficients, and can also be applied to other attribute coefficients, that is, can be applied in multi-attribute encoding scenarios; (2) the above embodiments are intended for only three attribute coefficients, where attribute coefficient 1 and attribute coefficient 2 are encoded to be both 0, and if the above embodiments are intended for four attribute coefficients, attribute coefficient 1, attribute coefficient 2, and attribute coefficient 3 can be extended to be all 0, and then encoded, etc.; (3) in the above embodiments, a coding order may vary, and an encoding order can be changed regarding which two of the attribute coefficients are first encoded to be both 0; (4) a context can be adaptively selected according to an encoded/decoded value in many ways. Adaptive selection of the context means that a context model is adaptively selected according to the magnitude of the encoded/decoded value, so as to encode/decode a next value.

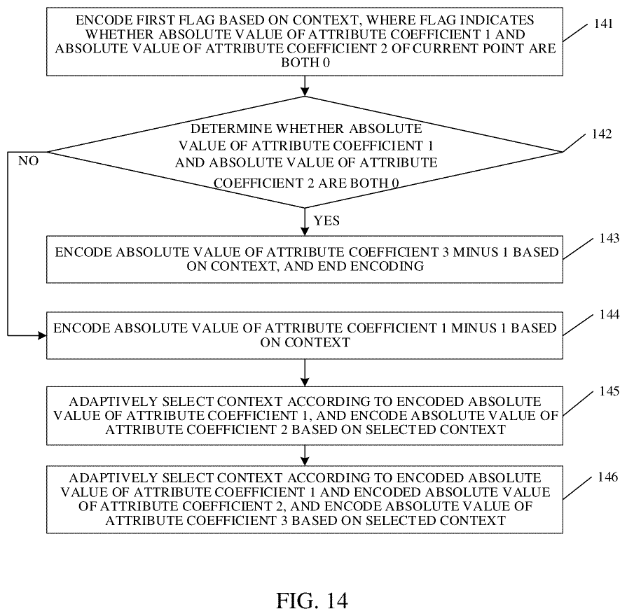

In addition, an encoding method is further provided in embodiments of the disclosure. FIG. 14 is a schematic flowchart illustrating implementation of an encoding method provided in embodiments of the disclosure. As illustrated in FIG. 14, the method includes operations at 141 to operations at 146 below.

At 141, a first flag is encoded based on a context. The flag indicates whether an absolute value of attribute coefficient 1 and an absolute value of attribute coefficient 2 of a current point are both 0.

At 142, whether the absolute value of attribute coefficient 1 and the absolute value of attribute coefficient 2 are both 0 is determined. If the absolute value of attribute coefficient 1 and the absolute value of attribute coefficient 2 are both 0, operations at 143 are performed, and otherwise, operations at 144 are performed.

At 143, an absolute value of attribute coefficient 3 minus 1 is encoded based on a context, and the encoding ends.

At 144, the absolute value of attribute coefficient 1 minus 1 is encoded based on a context, and the process proceeds to operations at 145.

At 145, a context is adaptively selected according to the encoded absolute value of attribute coefficient 1, the absolute value of attribute coefficient 2 is encoded based on the selected context, and the process proceeds to operations at 146.

At 146, a context is adaptively selected according to the encoded absolute value of attribute coefficient 1 and the encoded absolute value of attribute coefficient 2, and the absolute value of attribute coefficient 3 is encoded based on the selected context.

Finally, if the absolute value of attribute coefficient 1 is not 0, a sign of the absolute value of attribute coefficient 1 is encoded. If the absolute value of attribute coefficient 2 is not 0, a sign of the absolute value of attribute coefficient 2 is encoded. If the absolute value of attribute coefficient 3 is not 0, a sign of the absolute value of attribute coefficient 3 is encoded.

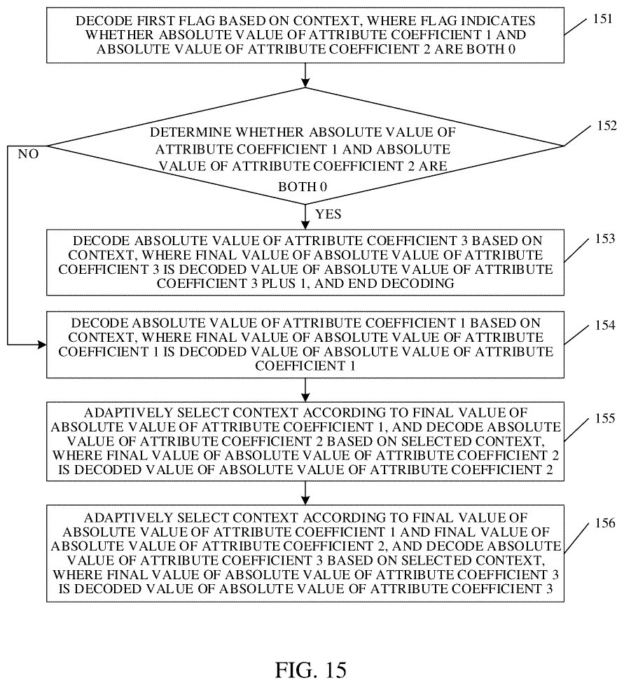

Accordingly, a decoding method is further provided in embodiments of the disclosure. FIG. 15 is a schematic flowchart illustrating implementation of a decoding method provided in embodiments of the disclosure. As illustrated in FIG. 15, the method includes operations at 151 to operations at 156 below.

At 151, a first flag is decoded based on a context. The flag indicates whether an absolute value of attribute coefficient 1 and an absolute value of attribute coefficient 2 are both 0.

At 152, whether the absolute value of attribute coefficient 1 and the absolute value of attribute coefficient 2 are both 0 is determined. If the absolute value of attribute coefficient 1 and the absolute value of attribute coefficient 2 are both 0, operations at 153 are performed, and otherwise, operations at 154 are performed.

At 153, an absolute value of attribute coefficient 3 is decoded based on a context, and the encoding ends, where a final value of the absolute value of attribute coefficient 3 is a decoded value of the absolute value of attribute coefficient 3 plus 1, and the decoding ends.

At 154, the absolute value of attribute coefficient 1 is decoded based on a context, where a final value of the absolute value of attribute coefficient 1 is a decoded value of the absolute value of attribute coefficient 1, and the process proceeds to operations at 155.

At 155, a context is adaptively selected according to the final value of the absolute value of attribute coefficient 1, and the absolute value of attribute coefficient 2 is decoded based on the selected context, where a final value of the absolute value of attribute coefficient 2 is a decoded value of the absolute value of attribute coefficient 2, and the process proceeds to operations at 156.

At 156, a context is adaptively selected according to the final value of the absolute value of attribute coefficient 1 and the final value of the absolute value of attribute coefficient 2, and the absolute value of attribute coefficient 3 is decoded based on the selected context. The final value of the absolute value of attribute coefficient 3 is the decoded value of the absolute value of attribute coefficient 3.

Finally, if the final value of the absolute value of attribute coefficient 1 is not 0, a sign of the final value of the absolute value of attribute coefficient 1 is decoded. If the final value of the absolute value of attribute coefficient 2 is not 0, a sign of the final value of the absolute value of attribute coefficient 2 is decoded. If the final value of the absolute value of attribute coefficient 3 is not 0, a sign of the final value of the absolute value of attribute coefficient 3 is decoded.

It may be noted that, although various operations of the method of the disclosure are described in a particular order in the accompanying drawings, this does not require or imply that the operations must be performed in the particular order, or that all of the operations illustrated must be performed to achieve a desired result. Additionally or alternatively, some operations may be omitted, multiple operations may be combined into one operation for performing, and/or one operation may be decomposed into multiple operations for performing. Alternatively, operations in different embodiments may be combined into a new technical solution.

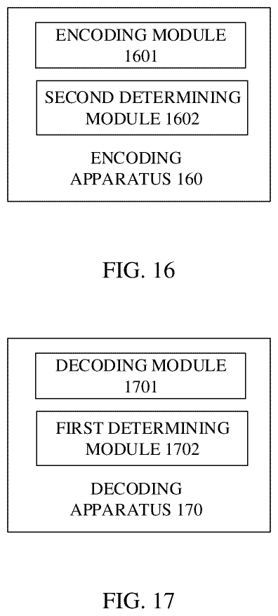

Based on the foregoing embodiments, an encoding apparatus is provided in embodiments of the disclosure. The encoding apparatus is applied to an encoder. FIG. 16 is a schematic structural diagram of an encoding apparatus provided in embodiments of the disclosure. As illustrated in FIG. 16, the encoding apparatus 160 includes an encoding module 1601 and a second determining module 1602. The encoding module 1601 is configured to encode a first flag to a point cloud bitstream, where the first flag indicates whether attribute coefficients of at least two first attribute components of a current point are each a first value. The second determining module 1602 is configured to encode a second attribute coefficient of a second attribute component of the current point to the point cloud bitstream, when the attribute coefficients of the at least two first attribute components are each the first value. The second attribute coefficient is equal to a first attribute coefficient of the second attribute component minus 1, and the second attribute component is different from the at least two first attribute components.

In some embodiments, the encoding module 1601 is configured to encode a first parameter to the point cloud bitstream. The encoding module 1601 is further configured to encode the first flag to the point cloud bitstream, when the number of points for which each attribute coefficient is the first value is the first value.

In some embodiments, the encoding module 1601 is configured to encode the first flag based on a first context.

In some embodiments, the encoding module 1601 is configured to encode the second attribute coefficient based on a second context.

In some embodiments, the encoding module 1601 is further configured to encode a second flag to the point cloud bitstream, when at least one of the attribute coefficients of the at least two first attribute components is not the first value. The second flag indicates whether an attribute coefficient of at least one first attribute component of the at least two first attribute components is the first value.

In some embodiments, the encoding module 1601 is further configured to encode a fourth attribute coefficient of a first attribute component different from the at least one first attribute component among the at least two first attribute components to the point cloud bitstream, when the attribute coefficient of the at least one first attribute component is the first value. The fourth attribute coefficient is equal to a third attribute coefficient of the first attribute component different from the at least one first attribute component minus 1.

In some embodiments, the encoding module 1601 is further configured to encode a fifth attribute coefficient of the second attribute component to the point cloud bitstream, when the attribute coefficient of the at least one first attribute component is the first value.

In some embodiments, the encoding module 1601 is configured to encode the fourth attribute coefficient based on a third context.

In some embodiments, the encoding module 1601 is configured to select a fourth context based on the third attribute coefficient or the fourth attribute coefficient, and encode a fifth attribute coefficient based on the fourth context.

In some embodiments, the encoding module 1601 is further configured to encode a seventh attribute coefficient of the at least one first attribute component to the point cloud bitstream, when the attribute coefficient of the at least one first attribute component is not the first value. The seventh attribute coefficient is equal to a sixth attribute coefficient of the at least one first attribute component minus 1.

In some embodiments, the encoding module 1601 is further configured to encode an eighth attribute coefficient of the first attribute component different from the at least one first attribute component among the at least two first attribute components to the point cloud bitstream, when the attribute coefficient of the at least one first attribute component is not the first value.

In some embodiments, the encoding module 1601 is further configured to encode a ninth attribute coefficient of the second attribute component to the point cloud bitstream, when the attribute coefficient of the at least one first attribute component is not the first value.

In some embodiments, the encoding module 1601 is configured to encode the seventh attribute coefficient of the at least one first attribute component based on a fifth context.

In some embodiments, the encoding module 1601 is configured to select a sixth context based on the sixth attribute coefficient or the seventh attribute coefficient, and encode the eighth attribute coefficient of the first attribute component different from the at least one first attribute component based on the sixth context.

In some embodiments, the encoding module 1601 is configured to select a seventh context based on the eighth attribute coefficient and/or one of the sixth attribute coefficient and the seventh attribute coefficient, and encode the ninth attribute coefficient of the second attribute component based on the seventh context.

In some embodiments, the encoding module 1601 is further configured to encode a tenth attribute coefficient of at least one first attribute component of the at least two first attribute components to the point cloud bitstream, when at least one of the attribute coefficients of the at least two first attribute components is not the first value. The encoding module 1601 is further configured to encode an eleventh attribute coefficient of a first attribute component different from the at least one first attribute component among the at least two first attribute components to the point cloud bitstream based on the tenth attribute coefficient. The encoding module 1601 is further configured to encode a twelfth attribute coefficient of the second attribute component to the point cloud bitstream based on the tenth attribute coefficient and the eleventh attribute coefficient.

In some embodiments, the encoding module 1601 is configured to encode the tenth attribute coefficient based on an eighth context, select a ninth context based on the tenth attribute coefficient, encode the eleventh attribute coefficient based on the ninth context, select a tenth context based on the tenth attribute coefficient and the eleventh attribute coefficient, and encode the twelfth attribute coefficient based on the tenth context.

In some embodiments, the encoding module 1601 is further configured to encode a sign of a final value of an attribute coefficient of any attribute component, when the final value of the attribute coefficient of any attribute component is not the first value. The sign indicates whether the final value of the corresponding attribute coefficient is positive or negative.

In some embodiments, the encoding apparatus 160 further includes a first reconstructing module. The first reconstructing module is configured to obtain an attribute reconstruction value of an attribute component at least according to an attribute coefficient of the attribute component. The attribute coefficient of the attribute component is one of: a first attribute coefficient, a third attribute coefficient, a fifth attribute coefficient, a sixth attribute coefficient, an eighth attribute coefficient, a ninth attribute coefficient, a tenth attribute coefficient, an eleventh attribute coefficient, and a twelfth attribute coefficient.

In some embodiments, the at least two first attribute components include a U component and a V component, and the second attribute component includes a Y component. Alternatively, the at least two first attribute components include a G component and a B component, and the second attribute component includes an R component.

A decoding apparatus is further provided in embodiments of the disclosure. The decoding apparatus is applied to a decoder. FIG. 17 is a schematic structural diagram of a decoding apparatus provided in embodiments of the disclosure. As illustrated in FIG. 17, the decoding apparatus 170 includes a decoding module 1701 and a first determining module 1702. The decoding module 1701 is configured to decode a point cloud bitstream to obtain a first flag, where the first flag indicates whether attribute coefficients of at least two first attribute components of a current point are each a first value. The first determining module 1702 is configured to determine that a first attribute coefficient of a second attribute component of the current point is equal to a second attribute coefficient of the second attribute component plus 1, when the first flag indicates that the attribute coefficients of the at least two first attribute components are each the first value. The second attribute coefficient of the second attribute component is parsed from the point cloud bitstream, and the second attribute component is different from the at least two first attribute components.

In some embodiments, the decoding module 1701 is configured to decode the point cloud bitstream to obtain a first parameter. The decoding module 1701 is further configured to decode the point cloud bitstream to obtain the first flag, when the first parameter is the first value.

In some embodiments, the decoding module 1701 is configured to decode, based on a first context, the point cloud bitstream to obtain the first flag.

In some embodiments, the decoding module 1701 is configured to decode, based on a second context, the point cloud bitstream to obtain the second attribute coefficient.

In some embodiments, the decoding module 1701 is further configured to determine a second flag, when the first flag indicates that at least one of the attribute coefficients of the at least two first attribute components is not the first value. The second flag indicates whether an attribute coefficient of at least one first attribute component of the at least two first attribute components is the first value.

In some embodiments, the decoding module 1701 is further configured to determine that a third attribute coefficient of a first attribute component different from the at least one first attribute component among the at least two first attribute components is equal to a fourth attribute coefficient of the first attribute component different from the at least one first attribute component plus 1, when the second flag indicates that the attribute coefficient of the at least one first attribute component is the first value. The fourth attribute coefficient is parsed from the point cloud bitstream.

In some embodiments, the decoding module 1701 is further configured to determine a fifth attribute coefficient of the second attribute component, when the second flag indicates that the attribute coefficient of the at least one first attribute component is the first value. The fifth attribute coefficient is parsed from the point cloud bitstream.

In some embodiments, the decoding module 1701 is configured to decode, based on a third context, the point cloud bitstream to obtain the fourth attribute coefficient.

In some embodiments, the decoding module 1701 is configured to select a fourth context based on the third attribute coefficient or the fourth attribute coefficient, and decode, based on the fourth context, the point cloud bitstream to obtain a fifth attribute coefficient.

In some embodiments, the decoding module 1701 is further configured to determine that a sixth attribute coefficient of the at least one first attribute component is equal to a seventh attribute coefficient of the at least one first attribute component plus 1, when the second flag indicates that the attribute coefficient of the at least one first attribute component is not the first value.

In some embodiments, the decoding module 1701 is further configured to determine an eighth attribute coefficient of the first attribute component different from the at least one first attribute component among the at least two first attribute components, when the second flag indicates that the attribute coefficient of the at least one first attribute component is not the first value. The eighth attribute coefficient is parsed from the point cloud bitstream.

In some embodiments, the decoding module 1701 is further configured to determine a ninth attribute coefficient of the second attribute component, when the second flag indicates that the attribute coefficient of the at least one first attribute component is not the first value. The ninth attribute coefficient is parsed from the point cloud bitstream.

In some embodiments, the decoding module 1701 is configured to decode, based on a fifth context, the point cloud bitstream to obtain the seventh attribute coefficient of the at least one first attribute component.

In some embodiments, the decoding module 1701 is configured to select a sixth context based on the sixth attribute coefficient or the seventh attribute coefficient, and decode, based on the sixth context, the point cloud bitstream to obtain the eighth attribute coefficient of the first attribute component different from the at least one first attribute component.

In some embodiments, the decoding module 1701 is configured to select a seventh context based on the eighth attribute coefficient and/or one of the sixth attribute coefficient and the seventh attribute coefficient, and decode, based on the seventh context, the point cloud bitstream to obtain the ninth attribute coefficient of the second attribute component.

In some embodiments, the decoding module 1701 is further configured to decode the point cloud bitstream to obtain a tenth attribute coefficient of at least one first attribute component of the at least two first attribute components, when the first flag indicates that at least one of the attribute coefficients of the at least two first attribute components is not the first value. The decoding module 1701 is further configured to decode, based on the tenth attribute coefficient, the point cloud bitstream to obtain an eleventh attribute coefficient of a first attribute component different from the at least one first attribute component among the at least two first attribute components. The decoding module 1701 is further configured to decode, based on the tenth attribute coefficient and the eleventh attribute coefficient, the point cloud bitstream to obtain a twelfth attribute coefficient of the second attribute component.

In some embodiments, the decoding module 1701 is configured to decode, based on an eighth context, the point cloud bitstream to obtain the tenth attribute coefficient. The decoding module 1701 is further configured to select a ninth context based on the tenth attribute coefficient. The decoding module 1701 is further configured to decode, based on the ninth context, the point cloud bitstream to obtain the eleventh attribute coefficient. The decoding module 1701 is further configured to select a tenth context based on the tenth attribute coefficient and the eleventh attribute coefficient. The decoding module 1701 is further configured to decode, based on the tenth context, the point cloud bitstream to obtain the twelfth attribute coefficient.

In some embodiments, the decoding module 1701 is further configured to decode the point cloud bitstream to obtain a sign of a final value of an attribute coefficient of any attribute component, when the final value of the attribute coefficient of any attribute component is not the first value. The sign indicates whether the final value of the corresponding attribute coefficient is positive or negative.

In some embodiments, the decoding apparatus 170 further includes a second reconstructing module. The second reconstructing module is configured to obtain an attribute reconstruction value of an attribute component at least according to an attribute coefficient of the attribute component. The attribute coefficient of the attribute component is one of: a first attribute coefficient, a third attribute coefficient, a fifth attribute coefficient, a sixth attribute coefficient, an eighth attribute coefficient, a ninth attribute coefficient, a tenth attribute coefficient, an eleventh attribute coefficient, and a twelfth attribute coefficient.

The above description of apparatus embodiments is similar to the above description of method embodiments. The apparatus embodiments have similar beneficial effects as the method embodiments. Technical details not disclosed in the apparatus embodiments in the disclosure are understood with reference to the description of method embodiments in the disclosure.

It may be noted that, the division of modules in the apparatus described in embodiments of the disclosure is illustrative and is only a division of logical functions, and other manners of division may also available in practice. In addition, various functional units described in various embodiments of the disclosure may be integrated into one processing unit, may be physically present alone, or may have two or more units integrated into one unit. The above integrated units may be implemented either in the form of hardware or in the form of software functional units, or may be implemented by a combination of software and hardware.

It may be noted that in embodiments of the disclosure, if the above methods are implemented as software functional modules and sold or used as standalone products, the above methods may be stored in a computer-readable storage medium. Based on such understanding, the essential technical solution of embodiments of the disclosure, or the portion that contributes to the related art may be embodied as software products. The computer software products are stored in a storage medium and may include multiple instructions that, when executed, can cause an electronic device to perform all or part of the methods described in embodiments of the disclosure. The storage media may include various media that can store program codes, such as a universal serial bus (USB) flash disk, a mobile hard drive, a read-only memory (ROM), a magnetic disk, or an optical disk. Therefore, embodiments of the disclosure are not limited to combinations with any specific hardware or software.

A computer-readable storage medium is provided in embodiments of the disclosure. The computer-readable storage medium is configured to store a computer program which, when executed, is operable to implement the video picture processing method at the encoder side or the video picture processing method at the decoder side.

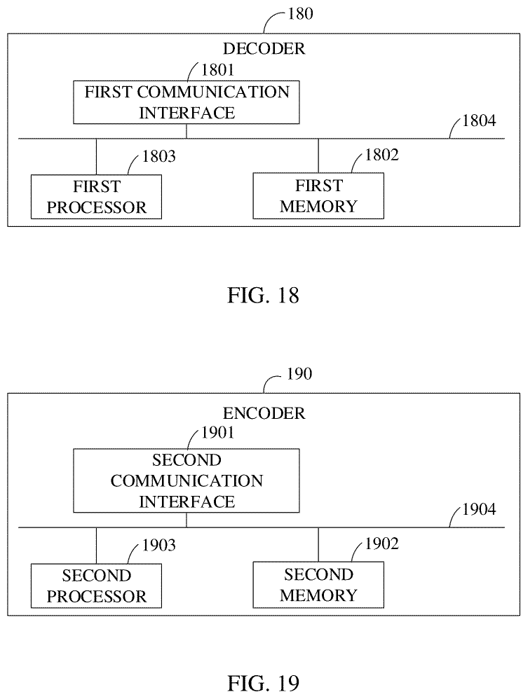

A decoder is provided in embodiments of the disclosure. As illustrated in FIG. 18, the decoder 180 includes a first communication interface 1801, a first memory 1802, and a first processor 1803. The components are coupled together via a first bus system 1804. It may be understood that the first bus system 1804 is configured to enable connection and communication between these components. The first bus system 1804 includes a power bus, a control bus, and a status signal bus in addition to a data bus. For the sake of clarity, however, the various buses are labelled as the first bus system 1804 in FIG. 18.

The first communication interface 1801 is configured to receive and transmit signals during information transmission with other external network elements.

The first memory 1802 is configured to store a computer program executable by the first processor 1803.

The first processor 1803 is configured to, when executing the computer program, perform the decoding method in embodiments of the disclosure.

It will be appreciated that the first memory 1802 in embodiments of the disclosure may be a transitory memory or non-transitory memory, or may include both transitory and non-transitory memory. In particular, the non-transitory memory may be an ROM, a programmable ROM (PROM), an erasable PROM (EPROM), an electrically EPROM (EEPROM), or a flash memory. The transitory memory may be a random access memory (RAM), which is used as an external cache. By way of illustration, but not limitation, many forms of RAM are available, such as a static RAM (SRAM), a dynamic RAM (DRAM), a synchronous DRAM (SDRAM), a double data rate synchronous random access memory (DDRSDRAM), an enhanced SDRAM (ESDRAM), a synchlink DRAM (SLDRAM), and a direct Rambus RAM (DRRAM). The first memory 1802 of the system and method described in this disclosure is intended to include, but is not limited to, these and any other suitable types of memory.

The first processor 1803 may be an integrated circuit chip with signal processing capabilities. During implementation, the operations in the above method may be accomplished by integrated logic circuitry in the hardware of the first processor 1803 or by instructions in the form of software. The first processor 1803 described above may be a general-purpose processor, a digital signal processor (DSP), an application specific integrated circuit (ASIC), a field programmable gate array (FPGA), or other programmable logic device, discrete gate or transistor logic device, discrete hardware component. The various methods, steps and logic block diagrams disclosed in embodiments of the disclosure may be implemented or performed. The general-purpose processor may be a microprocessor or the processor may also be any conventional processor, etc. The operations in the method disclosed in conjunction with embodiments of the disclosure may be performed directly by the hardware decoder processor or by a combination of hardware and software modules in the decoder processor. The software module may be located in a random memory, flash memory, read-only memory, programmable read-only memory or electrically erasable programmable memory, registers and other storage media mature in the art. The storage medium is located in the first memory 1802, and the first processor 1803 reads the information in the first memory 1802 and completes the operations of the above method in combination with its hardware.

It will be appreciated that these embodiments described in this disclosure may be implemented in hardware, software, firmware, middleware, microcode, or combinations thereof. For hardware implementations, the processing unit may be implemented in one or more ASIC, DSP, DSP Device (DSPD), programmable logic device (PLD), FPGA, general-purpose processor, controller, microcontroller, microprocessor, other electronic unit for performing the functions described in this disclosure, or a combination thereof. For software implementations, the technology described in this disclosure may be implemented by means of modules (e.g, procedures, functions, etc.) that perform the functions described in this disclosure. The software code may be stored in a memory and executed by a processor. The memory may be implemented in the processor or outside the processor.

Optionally, as another embodiment, the first processor 1803 is further configured to perform any one of the decoding method embodiments when executing the computer program.

An encoder is provided in embodiments of the disclosure. As illustrated in FIG. 19, the encoder 190 includes a second communication interface 1901, a second memory 1902, and a second processor 1903. The components are coupled together via a second bus system 1904. It may be understood that the second bus system 1904 is configured to enable connection and communication between these components. The second bus system 1904 includes a power bus, a control bus, and a status signal bus in addition to a data bus. For the sake of clarity, however, the various buses are labelled as second bus system 1904 in FIG. 19.

The second communication interface 1901 is configured to receive and transmit signals during information transmission with other external network elements.

The second memory 1902 is configured to store a computer program executable by the second processor 1903.

The second processor 1903 is configured to, when executing the computer program, perform the encoding method in embodiments of the disclosure.

Optionally, as another embodiment, the second processor 1903 is further configured to perform the encoding method embodiments when executing the computer program.

It may be understood that, in terms of hardware function, the second memory 1902 is similar to the first memory 1802, and the second processor 1903 is similar to the first processor 1803, which will not be repeated herein.

An electronic device is provided in embodiments of the disclosure. The electronic device includes a processor and a computer-readable storage medium. The processor is adapted to executing a computer program. The computer-readable storage medium is configured to store the computer program which, when executed by the processor, is operable to implement the encoding method and/or the decoding method in embodiments of the disclosure. The electronic device may be any type of device having video encoding and/or video decoding capabilities. For example, the electronic device may be a mobile phone, a pad, a laptop computer, a personal computer, a television, a projection device, or a monitoring device, etc.

It may be noted that, the above description of the storage medium and apparatus embodiments is similar to the above description of the method embodiments. The storage medium and apparatus embodiments have similar beneficial effects as the method embodiments. Technical details not disclosed in the storage medium and apparatus embodiments of the disclosure are understood with reference to the description of method embodiments in the disclosure.

It may be understood that, terms “embodiment” or “the embodiment” or “some embodiments” referred to herein mean that a particular feature, structure, or characteristic described in conjunction with the embodiment may be contained in at least one embodiment of the disclosure. Terms “in embodiment” or “in the embodiment” or “in some embodiments” appearing in various places in the specification do not necessarily refer to the same embodiment or implementation. The particular feature, structure, or characteristic described may be properly combined in any one or more embodiments. It may be understood that, in the above embodiments of the disclosure, a magnitude of a sequence number of each process does not mean an execution order, and the execution order of each process should be determined by its function and an internal logic and may not constitute any limitation to an implementation process of embodiments of the disclosure. The above sequence number of embodiments of the disclosure are for description only and do not represent the advantages and disadvantages of embodiments. The above description of the various embodiments tends to emphasize the differences between the various embodiments, mutual reference can be made to the same or similar part of the various embodiments and the same or similar part of the various embodiments, which will not be repeated herein for the sake of brevity.

The term “and/or” herein only describes an association relationship between associated objects, which means that there can be three relationships. For example, object A and/or object B can mean object A alone, both object A and object B exist, and object B alone.

It may be noted that, terms “include”, “comprise” as well as variations thereof are intended to cover non-exclusive inclusion, so that a process, method, object, or device that includes a set of elements includes not only those elements, but also other elements that are not explicitly listed, or elements inherent to such a process, method, object, or device. In the absence of further limitations, an element defined by the phrase “includes a . . . ” does not preclude the existence of another identical element in the process, method, object or device in which it is included.

In several embodiments provided in the disclosure, it may be understood that the disclosed device and method may be implemented in other manners. The above embodiments are merely illustrative, for example, the division of modules is only a division of logical functions, and other manners of division may also available in practice, e.g., multiple modules or assemblies may be combined or may be integrated into another system, or some features may be ignored or skipped. In addition, the coupling or direct coupling or communication connection between various components as illustrated or discussed may be an indirect coupling or communication connection through some interface, device, or module, and may be electrical, mechanical, or otherwise.

Separated modules as illustrated may or may not be physically separated. Components displayed as modules may or may not be physical modules, and may reside at one location or may be distributed to multiple networked units. Part or all of the modules may be selected according to practical needs to achieve desired objectives of the disclosure.

In addition, various functional modules described in embodiments of the disclosure may be integrated into one processing unit or may be present as a number of physically separated units, and two or more modules may be integrated into one unit. The integrated module may be implemented either in the form of hardware or in the form of hardware and software functional units.

It may be understood by those of ordinary skills in the art that, all or part of the operations of the method embodiments may be implemented by means of hardware associated with program instructions, and the above program may be stored in a computer-readable storage medium. The program, when executed, is operable to perform the operations of the method embodiments. The above storage medium includes various media that can store program codes, such as a mobile storage device, an ROM, a magnetic disk, or an optical disk.

Alternatively, if the above integrated units of the disclosure are implemented as software functional modules and sold or used as standalone products, the above integrated units of the disclosure may be stored in a computer-readable storage medium. Based on such understanding, the essential technical solution of embodiments of the disclosure, or the portion that contributes to the related art may be embodied as software products. The computer software products are stored in a storage medium and may include multiple instructions that, when executed, can cause an electronic device to perform all or part of the methods described in embodiments of the disclosure. The storage media include various media that can store program codes, such as a mobile storage device, an ROM, a magnetic disk, or an optical disk.

The methods disclosed in several method embodiments provided in the disclosure may be combined with each other without conflict, to obtain a new method embodiment.

The features disclosed in several product embodiments provided in the disclosure may be combined with each other without conflict, to obtain a new product embodiment.

The features disclosed in several method or apparatus embodiments provided in the disclosure may be combined with each other without conflict, to obtain a new method or apparatus embodiment.

The above are merely embodiments of the disclosure and are not intended to limit the scope of protection of the disclosure. Any modification and replacement made by those skilled in the art within the technical scope of the disclosure shall be included in the scope of protection of the disclosure. Therefore, the scope of protection of the disclosure shall be subject to the scope of protection of the claims.

What is claimed is:

1. A decoding method, performed by a decoder and comprising:
decoding a point cloud bitstream to obtain a first flag, wherein the first flag indicates whether attribute coefficients of at least two first attribute components of a current point are each a first value; and
in response to the first flag indicating that the attribute coefficients of the at least two first attribute components are each the first value, determining that a first attribute coefficient of a second attribute component of the current point is equal to a second attribute coefficient of the second attribute component plus 1, wherein the second attribute coefficient of the second attribute component is parsed from the point cloud bitstream, and the second attribute component is different from the at least two first attribute components.

2. The method of claim 1, further comprising:
decoding the point cloud bitstream to obtain a first parameter; and
in response to the first parameter being the first value, decoding the point cloud bitstream to obtain the first flag.

3. The method of claim 2, wherein
the first parameter indicates a number of consecutive points for which each attribute coefficient is the first value.

4. The method of claim 2, wherein
the first parameter indicates a number of consecutive groups for which each attribute coefficient is the first value.

5. The method of claim 1, further comprising:
decoding, based on a first context, the point cloud bitstream to obtain the first flag.

6. The method of claim 1, further comprising:
decoding, based on a second context, the point cloud bitstream to obtain the second attribute coefficient.

7. The method of claim 1, further comprising:
in response to the first flag indicating that at least one of the attribute coefficients of the at least two first attribute components is not the first value, determining a second flag, wherein the second flag indicates whether an attribute coefficient of at least one first attribute component of the at least two first attribute components is the first value.

8. The method of claim 7, further comprising:
in response to the second flag indicating that the attribute coefficient of the at least one first attribute component is the first value, determining that a third attribute coefficient of a first attribute component different from the at least one first attribute component among the at least two first attribute components is equal to a fourth attribute coefficient of the first attribute component different from the at least one first attribute component plus 1, wherein the fourth attribute coefficient is parsed from the point cloud bitstream.

9. The method of claim 7, further comprising:
in response to the second flag indicating that the attribute coefficient of the at least one first attribute component is the first value, determining a fifth attribute coefficient of the second attribute component, wherein the fifth attribute coefficient is parsed from the point cloud bitstream.

10. The method of claim 8, further comprising:
decoding, based on a third context, the point cloud bitstream to obtain the fourth attribute coefficient.

11. The method of claim 8, further comprising:
selecting a fourth context based on the third attribute coefficient or the fourth attribute coefficient; and
decoding, based on the fourth context, the point cloud bitstream to obtain a fifth attribute coefficient.

12. The method of claim 8, further comprising:
in response to the second flag indicating that the attribute coefficient of the at least one first attribute component is not the first value, determining that a sixth attribute coefficient of the at least one first attribute component is equal to a seventh attribute coefficient of the at least one first attribute component plus 1, wherein the seventh attribute coefficient is parsed from the point cloud bitstream.

13. The method of claim 1, further comprising:
in response to the first flag indicating that at least one of the attribute coefficients of the at least two first attribute components is not the first value, decoding the point cloud bitstream to obtain a tenth attribute coefficient of at least one first attribute component of the at least two first attribute components;
decoding, based on the tenth attribute coefficient, the point cloud bitstream to obtain an eleventh attribute coefficient of a first attribute component different from the at least one first attribute component among the at least two first attribute components; and
decoding, based on the tenth attribute coefficient and the eleventh attribute coefficient, the point cloud bitstream to obtain a twelfth attribute coefficient of the second attribute component.

14. The method of claim 13, further comprising:
decoding, based on an eighth context, the point cloud bitstream to obtain the tenth attribute coefficient;
selecting a ninth context based on the tenth attribute coefficient;
decoding, based on the ninth context, the point cloud bitstream to obtain the eleventh attribute coefficient;
selecting a tenth context based on at least one of the tenth attribute coefficient or the eleventh attribute coefficient; and
decoding, based on the tenth context, the point cloud bitstream to obtain the twelfth attribute coefficient.

15. The method of claim 1, further comprising:
in response to a final value of an attribute coefficient of any attribute component being not the first value, decoding the point cloud bitstream to obtain a sign of the final value of the attribute coefficient of any attribute component, wherein the sign indicates whether the final value of the corresponding attribute coefficient is positive or negative.

16. The method of claim 1, wherein the first value is 0.

17. The method of claim 1, further comprising:
obtaining an attribute reconstruction value of an attribute component at least according to an attribute coefficient of the attribute component, wherein the attribute coefficient of the attribute component is one of: a first attribute coefficient, a third attribute coefficient, a fifth attribute coefficient, a sixth attribute coefficient, an eighth attribute coefficient, a ninth attribute coefficient, a tenth attribute coefficient, an eleventh attribute coefficient, and a twelfth attribute coefficient.

18. The method of claim 1, wherein
the at least two first attribute components comprise a U component and a V component, and the second attribute component comprises a Y component; or
the at least two first attribute components comprise a G component and a B component, and the second attribute component comprises an R component.

19. An encoding method, performed by an encoder and comprising:
encoding a first flag to a point cloud bitstream, wherein the first flag indicates whether attribute coefficients of at least two first attribute components of a current point are each a first value; and
in response to the attribute coefficients of the at least two first attribute components being each the first value, encoding a second attribute coefficient of a second attribute component of the current point to the point cloud bitstream, wherein the second attribute coefficient is equal to a first attribute coefficient of the second attribute component minus 1, and the second attribute component is different from the at least two first attribute components.

20. A non-transitory computer-readable storage medium storing a point cloud bitstream, the point cloud bitstream being generated according to the following:
encoding a first flag to the point cloud bitstream, wherein the first flag indicates whether attribute coefficients of at least two first attribute components of a current point are each a first value; and
in response to the attribute coefficients of the at least two first attribute components being each the first value, encoding a second attribute coefficient of a second attribute component of the current point to the point cloud bitstream, wherein the second attribute coefficient is equal to a first attribute coefficient of the second attribute component minus 1, and the second attribute component is different from the at least two first attribute components.
